(19) United States
(12) Patent Application Publication
(10) Pub. No.: US 2026/0361105 A1
(43) Pub. Date: Nov. 12, 2026

(54) CHARGING DEVICE

(71) Applicant: Shenzhen Lanhe Technologies Co., Ltd., Shenzhen (CN)

(72) Inventors: Linzhong HUANG, Shenzhen (CN); Xinping XIE, Shenzhen (CN); Pengning LUO, Shenzhen (CN); Zhi TIAN, Shenzhen (CN); Meiren PENG, Shenzhen (CN); Xiaoyu NIU, Shenzhen (CN); Hui GUO, Shenzhen (CN)

(73) Assignee: Shenzhen Lanhe Technologies Co., Ltd., Shenzhen (CN)

(21) Appl. No.: 19/719,274

(22) Filed: Jun. 25, 2026

Related U.S. Application Data
(63) Continuation-in-part of application No. PCT/CN2024/142519, filed on Dec. 25, 2024.

(30) Foreign Application Priority Data
Dec. 26, 2023 (CN) 202311808479.7
May 9, 2024 (CN) 202420990687.7
Sep. 30, 2025 (CN) 202522124392.9
Feb. 3, 2026 (CN) 202610157879.3

(51) Int. Cl. H02J 7/70

(52) U.S. Cl. CPC H02J 7/70

(57) ABSTRACT

A charging device includes a housing having an inner chamber and an opening in communication with the inner chamber; a heat-exchange assembly, having a first portion located in the inner chamber and a second portion extending out of the inner chamber via the opening; an internal electronic unit, arranged in the inner chamber and being in thermal-conduction connection with the first portion of the heat-exchange assembly; and plug pins, connected to the second portion of the heat-exchange assembly. Each of the plug pins has an end electrically connected to the internal electronic unit in the inner chamber, as well as an opposite end extending out of the inner chamber through the second portion. The charging device provided by the embodiments of the present application avoids thermal discomfort on the hands while maintaining efficient heat dissipation of the internal electronic unit in the charging device.

### CROSS REFERENCE TO RELATED APPLICATIONS

This application is a continuation-in-part of International Patent Application No. PCT/CN2024/142519, filed on Dec. 25, 2024, which claims priority of China Patent Application No. 202311808479.7 filed on Dec. 26, 2023 and China Patent Application No. 202420990687.7 filed on May 9, 2024. This application also claims priority of China Patent Application No. 202522124392.9 filed on Sep. 30, 2025 and China Patent Application No. 202610157879.3 filed on Feb. 3, 2026. The contents of the above-identified applications are incorporated herein by reference.

### FIELD

The present application relates to the field of electronic product accessories, in particular to a charging device.

### BACKGROUND

Electronic products such as mobile phones, tablets and laptops generally need to be charged by charging devices such as power adapters. As people's requirements for the charging speed change, the fast-charging technology has become matured gradually. However, charging devices with the fast-charging function have an excessively high temperature in operation. Existing charging devices usually conduct heat produced by internal electronic units to the surfaces of the charging devices, which leads to a relatively high temperature of the entire housing. As a result, excessive heat generated during operation may lead to thermal discomfort on the user's hand when unplugging the charging devices from sockets after charging.

In view of this, how to avoid thermal discomfort on the hands while maintaining efficient heat dissipation of internal electronic units in charging devices become an issue urgently to be settled.

### SUMMARY

To overcome at least some defects and deficiencies in the prior art, the embodiments of the present application provide an improved charging device, which avoids thermal discomfort while maintaining good heat dissipation effect.

In one aspect, the present application provides a charging device which comprises a housing comprising an internal chamber and an opening in communication with the internal chamber; an internal electronic unit disposed in the internal chamber; a cover disposed at the opening and covering the internal chamber, a surface of the cover away from the internal chamber being provided with a plurality of fins arranged at an interval; and plug pins mounted to the cover, each of the plug pins comprising an end disposed in the internal chamber and electrically connected to the internal electronic unit and another end extending out of the cover.

In some embodiments, the cover comprises receiving slots corresponding to the plug pins in a one-to-one correspondence; the receiving slots extend in a lateral direction of the housing which is parallel to a length direction of the fins; and the plug pins are movable relative to the cover between a retracted position in which the plug pins are received in the receiving slots respectively and an extended position in which the plug pins are moved out of the receiving slots.

In some embodiments, each of the receiving slots comprises an end extending through a side wall of the cover laterally. When the plug pins are in the retracted position, the another ends of the plug pins extend out of the receiving slots and beyond the side wall of the cover laterally.

In some embodiments, the internal electronic unit comprises a first circuit board and a rectifier chip which is arranged on a surface of the first circuit board adjacent to an inner wall of housing.

In some embodiments, the internal electronic unit further comprises a second circuit board which is connected to and perpendicular with the first circuit board; and a transformer and at least one capacitor are arranged on the second circuit board.

In some embodiments, the at least one capacitor comprises a first capacitor and a second capacitor which are arranged at interval at an end of the circuit board adjacent to the cover; and the transformer is arranged at another end of the second circuit board away from the cover.

In some embodiments, the housing comprises a connecting hole arranged at an end thereof opposite to the cover; and the internal electronic unit comprises an electric connector aligning with the connecting hole in a longitudinal direction of the housing, and the electric connector is arranged on the first circuit board or the second circuit board.

In some embodiments, the housing comprises an inner shell and an outer shell around the inner shell; the internal chamber is formed within the inner shell; an end of the outer shell is connected to the cover; and the outer shell is made of a transparent material.

In some embodiments, the charging device further comprises a bracket arranged in the internal chamber; and the bracket is connected to the internal electronic unit or the cover.

In some embodiments, the bracket has a ring structure. The bracket and the cover are separately formed and assembled together.

In some embodiments, the bracket is a thermally-conductive bracket which comprises a ring-shaped base and a thermally-conductive extension; and the thermally-conductive extension extends from the ring-shaped base in a direction away from the cover and is connected to the housing or the internal electronic unit.

In some embodiments, the housing comprises an inner shell, an outer shell sleeved around the inner shell, and a thermal spreading layer disposed between the inner shell and the outer shell, and the internal chamber is defined in the inner shell.

In some embodiments, the inner shell, the outer shell and the cover cooperatively enclose and seal the thermal spreading layer.

In some embodiments, an edge of the inner shell is connected to an edge of the outer shell such that the thermal spreading layer is enclosed and sealed between the inner shell and the outer shell; or an edge of the cover is connected to an edge of at least one of the inner shell and the outer shell to seal the thermal spreading layer.

In some embodiments, the outer shell comprises a first bent section extending toward a center axis of the internal chamber; the thermal spreading layer comprises a connecting portion adjacent to the opening; and the outer shell extends beyond the thermal spreading layer in a direction parallel with the center axis of the internal chamber with the first bent section covering the connecting portion of the thermal spreading layer.

In some embodiments, the inner shell and the outer shell both are made of electrically insulating material, and the thermal spreading layer is made of metal; or at least a portion of the inner shell is made of a thermal-conductive material with a thermal conductivity greater than that of the outer shell but less than that of the thermal spreading layer.

In some embodiments, a connecting hole extends through the outer shell, the thermal spreading layer and the inner shell sequentially to allow a male connector terminal to pass therethrough to electrically connect with the internal electronic unit; and a wrapping section extends from the inner shell or the outer shell to cover a portion, surrounding the connecting hole, of the thermal equalization layer and isolate the male connector terminal from the thermal equalization layer.

In another aspect, the present application provides a charging device which comprises a housing comprising an internal chamber and an opening in communication with the internal chamber; an internal electronic unit disposed in the internal chamber; a cover attached to the housing and covering the internal chamber; a thermally-conductive bracket arranged in the internal chamber and in thermal conduction with the internal electronic unit and the cover; and plug pins mounted to the cover, each of the plug pins comprising an end disposed inside the internal chamber and electrically connected to the internal electronic unit, and another end extending through the cover to outside the internal chamber.

In some embodiments, the cover is arranged at the opening, and a surface, facing away from the housing, of the cover is exposed out of the inner chamber and provided with a plurality of fins arranged at an interval.

In some embodiments, the internal electronic unit comprises a first circuit board and a second circuit board, the first circuit board and the second circuit board are perpendicular to each other, and at least one of the first circuit board and the second circuit board is connected to the thermally-conductive bracket.

### BRIEF DESCRIPTION OF THE DRAWINGS

To more clearly explain the technical solutions in the embodiments of the present application, drawings used for describing the embodiments are briefly introduced below. Obviously, the drawings in the following description merely illustrate some embodiments of the present application. For those ordinarily skilled in the art, other drawings may be obtained on the basis of the following ones without creative labor.

FIG. 1 is a schematic structural diagram of a charging device according to one embodiment of the present application.

FIG. 2 is a schematic exploded structural view of the charging device shown in FIG. 1.

FIG. 3 is a schematic exploded structural view of an internal electronic unit in the charging device shown in FIG. 1.

FIG. 4 is a schematic side view of the charging device shown in FIG. 1 in a case where an outer shell is removed.

FIG. 5 is a schematic structural diagram of the charging device shown in FIG. 1, from another perspective.

FIG. 6 is an enlarged view of area A in FIG. 5.

FIG. 7 is a schematic structural diagram of the charging device shown in FIG. 1, in another direction.

FIG. 8 is a schematic exploded structural view of the charging device shown in FIG. 7.

FIG. 9 is a schematic structural diagram of a charging device according to another embodiment of the present application.

FIG. 10 is a schematic exploded structural view of the charging device shown in FIG. 9.

FIG. 11 is a schematic structural diagram of an internal electronic unit and a thermally-conductive bracket in the charging device shown in FIG. 9.

FIG. 12 is a schematic exploded view of the internal electronic unit and the thermally-conductive bracket shown in FIG. 11.

FIG. 13 is a schematic exploded view of a cover and the thermally-conductive bracket in the charging device shown in FIG. 9.

FIG. 14 is a schematic structural diagram of the thermally-conductive bracket in the charging device shown in FIG. 9.

FIG. 15 is a schematic sectional view of the charging device shown in FIG. 9 in a case where a housing is removed.

FIG. 16 is another schematic sectional view of the charging device shown in FIG. 9 in a case where the housing is removed.

FIG. 17 is a perspective view of a casing of an electronic device according to an embodiment of the present invention.

FIG. 18 is an exploded view of FIG. 17.

FIG. 19 is a cross-sectional view of FIG. 17 along one direction.

FIG. 20 is a cross-sectional view of FIG. 17 along another direction.

FIG. 21 is an enlarged view of an encircled portion A in FIG. 20.

FIG. 22 is an enlarged schematic view of an encircled portion B in FIG. 20.

FIG. 23 is a cross-sectional view of a casing of an electronic device according to an alternative embodiment of the present invention.

FIG. 24 is an enlarged schematic view of an encircled portion C in FIG. 23.

FIG. 25 is an enlarged schematic view of an encircled portion D in FIG. 23.

FIG. 26 is a schematic diagram of a connection structure between the housing and the cover according to another alternative embodiment of the present invention.

FIG. 27 is a structural schematic diagram of the heat spreading layer in FIG. 26.

FIG. 28 is an exploded view of a charging device according to an embodiment of the present invention.

FIG. 29 is a cross-sectional view of the charging device of FIG. 28 in an assembled state.

FIG. 30 is similar to FIG. 28, with the housing being removed.

FIG. 31 is an assembled view of FIG. 28, showing the plug pins in the retracted position.

FIG. 32 is an assembled view of FIG. 28, showing the plug pins in the extended position.

FIG. 33 is a cross-sectional view of a charging device according to an alternative embodiment of the present invention.

FIG. 34 is an enlarged schematic view of an encircled portion E in FIG. 33.

FIG. 35 is an exploded view of the cover in FIG. 33.

FIG. 36 is a cross-sectional view of a charging device according to another alternative embodiment of the present invention.

FIG. 37 is an enlarged schematic view of an encircled portion F in FIG. 36.

FIG. 38 is a cross-sectional view of a charging device according to further another alternative embodiment of the present invention.

FIG. 39 is an enlarged schematic view of an encircled portion G in FIG. 38.

### REFERENCE SIGNS

100, charging device; 10, housing; 12, outer shell; 13, inner chamber; 14, inner shell; 15, opening; 16, connecting hole; 17, fixing bracket; 20, internal electronic unit; 21, target device to be cooled; 211, rectifier chip; 212, transformer; 213, filter device; 2131, first capacitor; 2132, second capacitor; 22, first circuit board; 23, second circuit board; 24, electrical connector; 30, plug pin; 40, heat-exchange assembly; 41, thermally-conductive bracket; 4101, first end surface; 42, thermally-conductive extension; 421, first extension; 422, second extension; 423, third extension; 4231, first surface; 4232, second surface; 43, cover; 4301, second end surface; 431, fin; 432, receiving slot; 433, groove; 44, protrusion.

### DESCRIPTION OF THE EMBODIMENTS

To better clarify the objectives, technical solutions and advantages of the embodiments of the present application, the technical solutions in the embodiments of the present application are clearly and completely described below in conjunction with accompanying drawings. Obviously, the embodiments described below are merely illustrative ones rather than all possible ones of the present application. All other embodiments obtained by those ordinarily skilled in the art on the basis of the embodiments described here without creative labor should also fall within the protection scope of the present application.

It should be noted that all directional indications (such as “upper”, “lower”, “left”, “right”, “front”, “back”, “top” and “bottom”) in the embodiments of the present application are merely used for explaining relative positional relationships and movements between components in a specific posture (as shown below). When the specific posture changes, the directional indications will change accordingly.

Terms such as “first” and “second”, if any, involved in the embodiments of the present application are merely used for the purpose of description, and should not be construed as indicating or implying relative importance or implicitly indicating the number of technical features referred to. Therefore, a feature defined by “first” or “second” may explicitly or implicitly indicate the inclusion of at least one said feature.

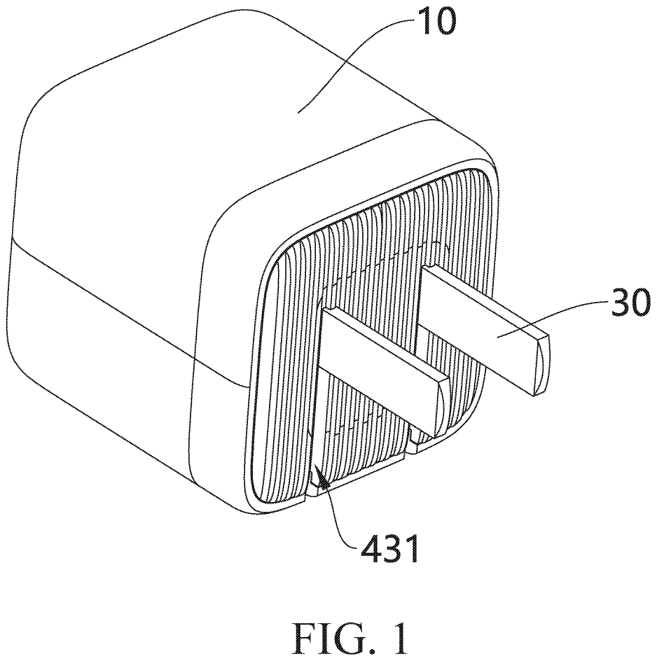

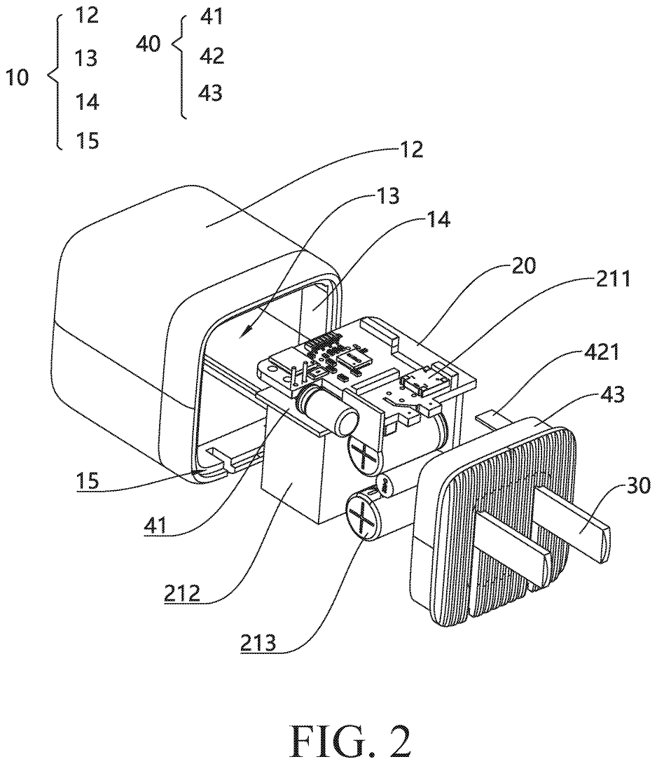

Referring to FIG. 1, one embodiment of the present application provides a charging device 100. The charging device 100 includes a housing 10, a heat-exchange assembly 40, an internal electronic unit 20 (refer to FIG. 2) and plug pins 30. Referring to FIG. 2, the housing 10 comprises an internal chamber 13 and an opening 15 in communication with the internal chamber 13. The internal electronic unit 20 is arranged in the internal chamber 13. A first portion of the heat-exchange assembly 40 is arranged in the internal chamber 13 and is in thermal-conduction connection with the internal electronic unit 20, and a second portion of the heat-exchange assembly 40 extends out of the internal chamber 13 via the opening 15. The plug pins 30 are connected to the second portion of the heat-exchange assembly 40. Each of the plug pins 30 has an end electrically connected to the internal electronic unit 20 in the internal chamber 13, as well as an opposite end extending out of the internal chamber 13 through the second portion. The ends of the plug pins 30 electrically connected to the internal electronic unit 20 can be called as inner ends while the opposite ends extending out of the internal chamber 13 can be called as outer ends.

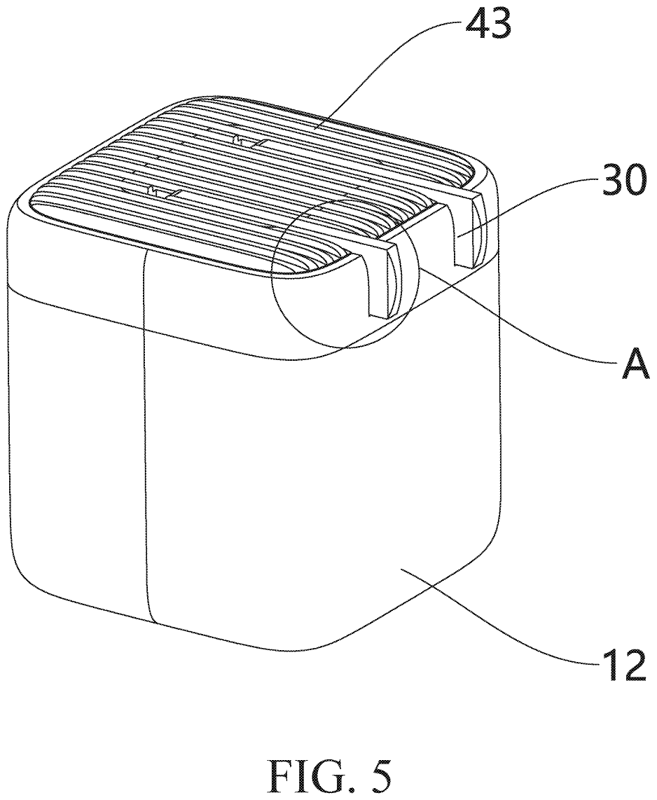

The charging device 100 provided by this embodiment of the present application may be a power adapter or a charger stick that may be used for charging various electronic products (e.g., mobile phones, computers, tablets, and portable temperature control devices). The plug pins 30 are configured to be plugged into a socket to conduct current into the internal electronic unit 20. The internal electronic unit 20, for example, includes a power management circuit, components constituting the power management circuit, a circuit board for providing support and contacts for the power management circuit, an output interface for outputting current to an electronic product to be charged, and the like. When the charging device 100 provided by this embodiment is used for charging an electronic product to be charged, the plug pins 30 are plugged into a socket, and current input from the socket is regulated by the internal electronic unit 20 and then output via the output interface to the electronic product to be charged, so as to implement charging. During the charging process, since the first portion of the heat-exchange assembly 40 is in thermal-conduction connection with the internal electronic unit 20 and the second portion of the heat-exchange assembly 40 extends out of the internal chamber 13, heat produced by the internal electronic unit 20 may be quickly conducted to the second portion via the first portion and finally dissipated out of the internal chamber 13. Referring to FIG. 5, the second portion of the heat-exchange assembly 40, for example, may define receiving slots 432 for receiving the plug pins 30, and the plug pins 30 are movably connected to the second portion of the heat-exchange assembly 40, such that the plug pins 30, for example, may be received in the receiving slots after charging is completed, thus facilitating storage of the charging device 100.

Since the plug pins 30 extend through the second portion of the heat-exchange assembly 40 outside of the internal chamber 13, when the plug pins 30 of the charging device 100 are plugged into a socket by users, the second portion of the heat-exchange assembly 40 is located on a side, facing the socket, of the housing 10, that is, the second portion of the heat-exchange assembly 40 is located on a side inaccessible to users, such that heat may be conducted to a non-conventional contact surface by means of the heat-exchange assembly 40. Since the side where the plug pins 30 are located is inaccessible to users during the charging process and when the charging device 100 is unplugged from the socket after charging is completed, that is, the users will not touch the second portion of the heat-exchange assembly 40, thermal discomfort on the hands is avoided. The housing 10, for example, includes an outer shell 12, and the outer shell 12, for example, may be made from a low-thermal-conductivity material or may be spaced apart from the internal electronic unit 20, or a thermal insulation material is arranged between the outer shell 12 and the internal electronic unit 20. Alternatively, the housing 10 includes an outer shell 12 and an inner shell 14, the outer shell 12 is isolated from the internal electronic unit 20 by the inner shell 14 to ensure that heat is conducted out mainly from the second portion of the heat-exchange assembly 40 and will not be conducted to the outer surface of the outer shell 12.

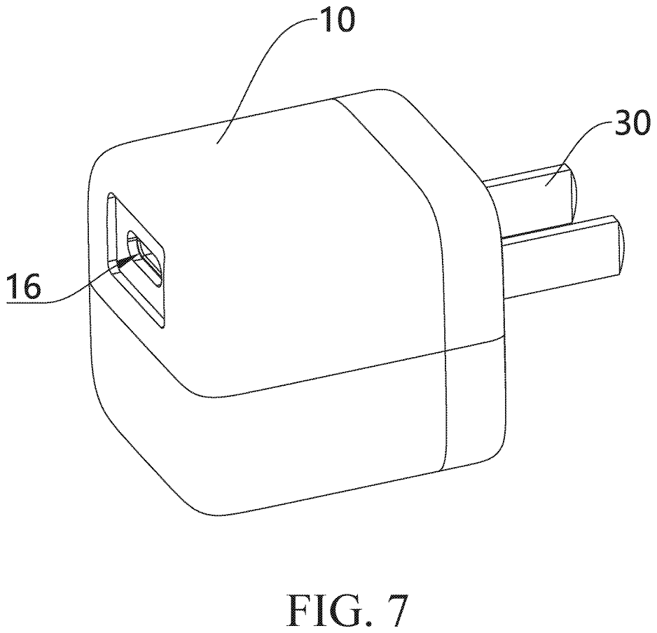

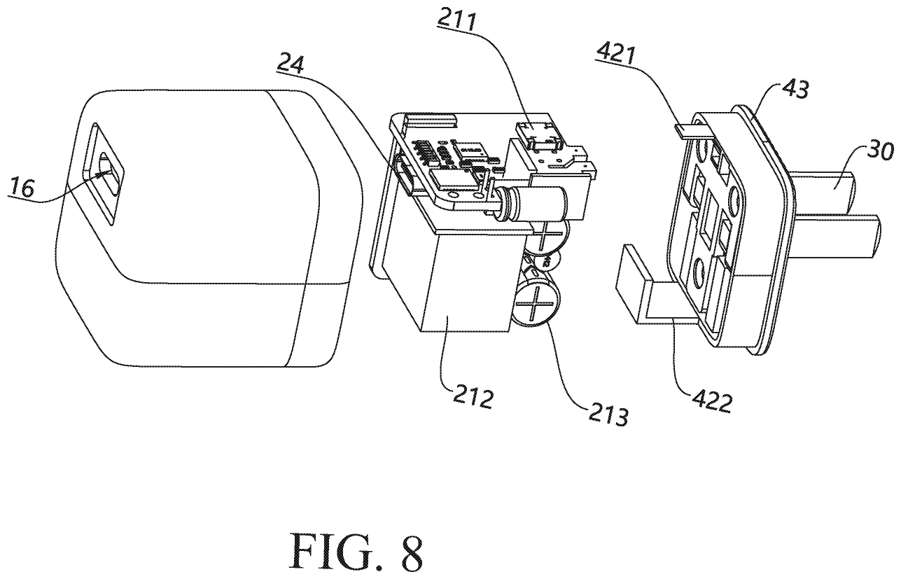

In some embodiments, referring to FIGS. 7 and 8, a connecting hole 16 is formed in a side, facing away from the opening 15, of the housing 10, the internal electronic unit 20 includes an electrical connector 24 corresponding to the connecting hole 16, and an external connector may be electrically connected to the electrical connector 24 via the connecting hole 16. The electrical connector 24 acts as an output interface electrically connected to the power management circuit inside the housing 10, and the external connector, for example, is a charging interface on a device to be charged or an input interface on a data cable or a charging cable. During the charging process, the external connector may be connected to the electrical connector 24 via the connecting hole 16 to conduct current to the device to be charged. When charging is ended, the external connector may be unplugged from the charging device 100, and in this process, users may come into contact with the housing 10. In this embodiment, the connecting hole 16 is defined in the side, away from the opening 15, of the housing 10 (i.e., the connecting hole 16 is arranged in the side away from the second portion of the heat-exchange assembly 40), such that the connecting hole 16 is kept away from the portion through which heat is dissipated, thereby avoiding thermal discomfort on the hands of the users when the users unplug the external connector.

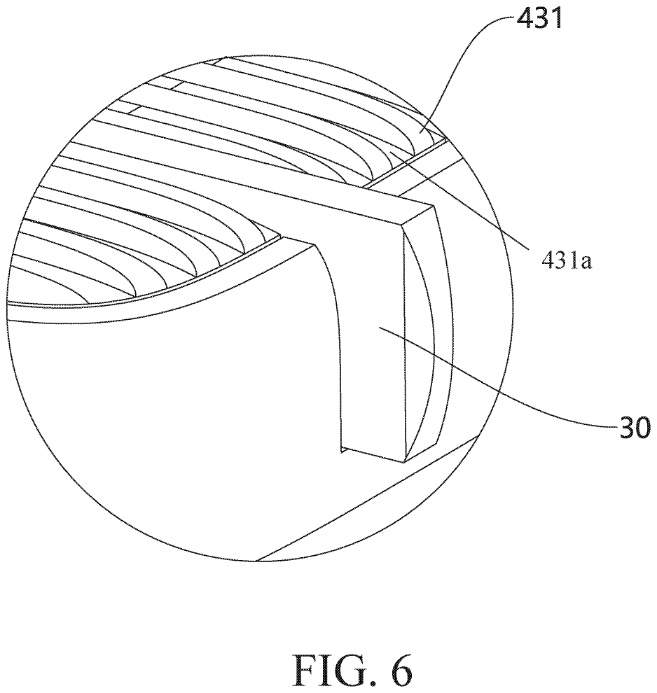

In the aforesaid embodiment, the second portion of the heat-exchange assembly 40, for example, includes a cover 43 which is arranged at the opening 15 and covers the internal chamber 13. A surface, facing away from the housing 10, of the cover 43 is exposed out of the internal chamber 13, and the plug pins 30 extend through the cover 43. In this way, heat conducted out through the second portion may come into contact with ambient air outside the internal chamber 13 by means of the surface, facing away from the housing 10, of the cover 43, so as to be dissipated into the air. In some embodiments, referring to FIGS. 1, 5 and 6, a plurality of heat dissipation protrusions is arranged on a surface, away from the internal chamber 13, of the cover 43, and the plurality of heat dissipation protrusions are spaced apart from each other. Thus, a plurality of heat dissipation channels is formed between adjacent heat dissipation protrusions for external air to pass therethrough. The heat dissipation protrusions arranged at intervals can increase the contact area between the cover 43 and external air, so as to enhance heat dissipation performance. Preferably, the heat dissipation protrusions are arranged at equal intervals. The space/distance between adjacent protrusions may be set in a range of 0.5 mm to 5 mm. Preferably, the heat dissipation protrusions comprise heat dissipation fins 432 which may be arranged parallel to one another at equal intervals. The channels 431a formed between adjacent fins 431 have the same width which can be in a range of 0.5 mm to 5 mm. The length direction of the fins 431 is perpendicular to the longitudinal direction of the housing 10 and the height direction of the fins 431 is parallel to the longitudinal direction of the housing 10. Each fin 431 has curved outer surfaces formed at opposite ends in the length direction thereof such that the height of opposite ends of the fin 431 reduce gradually in the length direction toward the side wall of the housing 10. The ends of the fins 431 are adjacent to the end of the housing 10 surrounding the opening 15. Thus, a smooth transition is formed between the outer surface of the ends of the fins 432 and the end surface of the housing 10. The curved outer surfaces formed at the ends of the fins 431 are outwardly convex. Alternatively, the heat dissipation protrusions may comprise heat dissipation posts/rods/projections/bulges/protuberances. The receiving slots 432 extend in a lateral direction of the housing 10 which is parallel to the length direction of the fins 431; and the plug pins 30 are movable relative to the cover 43 between a retracted position in which the plug pins 30 are received in the receiving slots 432 respectively and an extended position in which the plug pins 30 are moved out of the receiving slots 432. Each of the receiving slots 432 comprises an end extending through a side wall of the cover 43 laterally. When the plug pins 30 are in the retracted position, the outer ends of the plug pins 30 extend out of the receiving slots 432 and beyond the side wall of the cover 43 laterally. The side walls of the cover 43 conform to the contour of the opening 15. A shoulder is formed at the bottom of the opening 15. A mating shoulder is provided at the periphery of the cover 43 adjacent to the side walls of the cover 43. When the cover 43 is fitted into the opening 15, the two shoulders abut each other to position the cover 43 in the housing 10 in the longitudinal direction of the housing 10.

The first portion of the heat-exchange assembly 40, for example, may be a thermally conductive adhesive filled between the cover 43 and the internal electronic unit 20, or may be other thermally conductive materials.

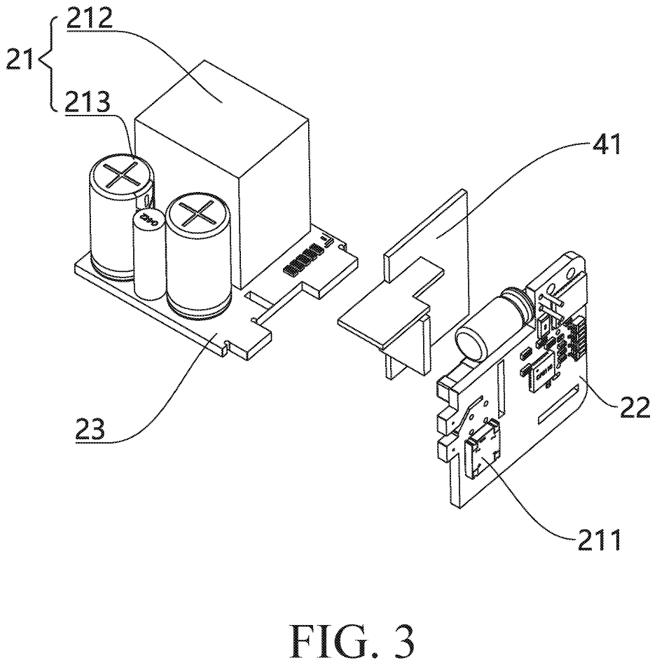

In some embodiments, the first portion of the heat-exchange assembly 40 includes a bracket. The bracket may be arranged in the internal chamber 13 and connected to the internal electronic unit 20 or the cover 43. The bracket may be a thermally-conductive bracket 41 which may support the internal electronic unit 20. Referring to FIGS. 2 and 3, the internal electronic unit 20, for example, includes a first circuit board 22 and a second circuit board 23. A plurality of components are arranged on each of the first circuit board 22 and the second circuit board 23, and the first circuit board 22 and the second circuit board 23 are perpendicular to each other, such that the structure is more compact. At least one of the first circuit board 22 and the second circuit board 23 is connected to the thermally-conductive bracket 41, such that the first circuit board 22 and the second circuit board 23 are supported by the thermally-conductive bracket 41 to integrate the internal electronic unit 20 into a whole, thereby facilitating assembly. In addition, the thermally-conductive bracket 41 has a large contact area with the first circuit board 22 and the second circuit board 23, such that heat produced by the internal electronic unit 20 may be conducted onto the cover 43 by means of the thermally-conductive bracket 41, thereby achieving an improved thermal-conduction effect. By adopting the above technical solution provided by this embodiment, the thermally-conductive bracket 41 integrates both the support function and the heat conduction function, such that the interior space in the internal chamber 13 is rationally used to make the charging device 100 more compact in structure, thereby reducing the size and saving materials.

In some embodiments, an end, close to the cover 43, of the thermally-conductive bracket 41 is connected to a middle portion of the cover 43. Thus, heat produced by the internal electronic unit 20 can be conducted by the thermally-conductive bracket 41 to the middle portion of the cover 43 and is then uniformly dissipated out via the cover 43, such that heat conduction is faster, and the thermal-conduction effect is improved.

In some embodiments, the internal electronic unit 20 includes a target device 21 to be cooled, the first portion of the heat-exchange assembly 40 includes a thermally-conductive extension 42, and the thermally-conductive extension 42 extends into the internal chamber 13 from a side, close to the internal chamber 13, of the cover 43 and is in thermal-conduction with the target device 21 to be cooled. The target device 21 to be cooled refers to a component that produces a relatively large quantity of heat when the charging device 100 operates, such as a transformer, a capacitor, a chip, or the like. For example, there may be a plurality of target devices 21 to be cooled, and the thermally-conductive extension 42 extends onto at least one of the plurality of target devices 21 to be cooled. By means of the thermally-conductive extension 42, heat conduction may be emphatically performed on a region, where a relatively large quantity of heat is produced, in the internal electronic unit 20, such that heat may be conducted out quickly.

For example, referring to FIG. 2, the plurality of target devices 21 to be cooled include a rectifier chip 211, the thermally-conductive extension 42 includes a first extension 421, and the first extension 421 extends to the rectifier chip 211 and is in thermal connection with the rectifier chip 211. Preferably, the rectifier chip 211 comprises a major surface parallel with the circuit board 22 and the first extension 421 comprises a contact surface which is parallel with the circuit board 22 and in contact with the major surface of the rectifier chip 211. When the charging device 100 operates, 100, the plug pins 30 are plugged into a socket to conduct alternating current into the internal electronic unit 20, and at this moment, the alternating current needs to be rectified and filtered. The rectifier chip 211 comprises a plurality of diodes, functions as a part for rectifying the alternating current in the internal electronic unit 20, and may adjust the direction of the current. In this embodiment, the first extension 421 is in thermal contact with the rectifier chip 211 such that heat may be quickly conducted from the rectifier chip 211 to the first extension 421 and then be transferred to the cover 43.

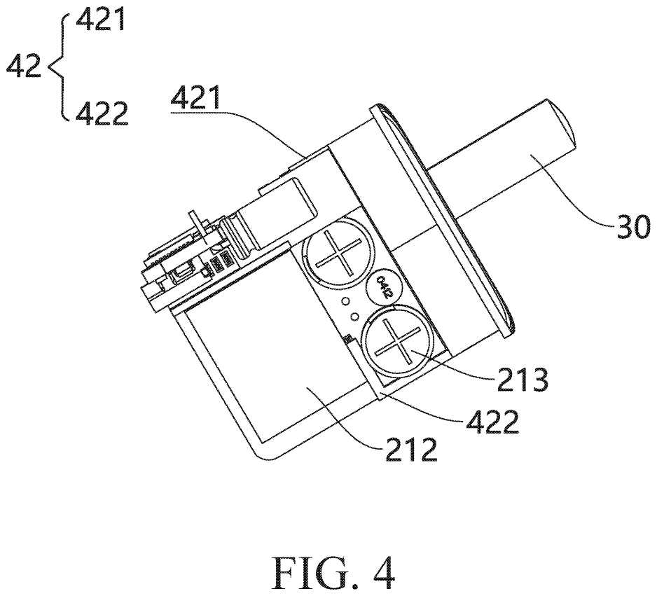

In some embodiments, referring to FIG. 4, the plurality of target devices 21 to be cooled include a filter device 213 and a transformer 212, the thermally-conductive extension 42 includes a second extension 422, and the second extension 422 extends into a gap between the filter device 213 and the transformer 212. The filter device 213, for example, is one of circuit components for converting a high-voltage power supply in the charging device 100, and is used for converting pulsating direct-current high voltage input by a rectifier circuit into a stable direct-current high voltage suitable for the transformer 212. The transformer 212 is configured for converting the direct-current high voltage, transmitted from the filter device 213, into direct-current low voltage suitable for an electronic device to be charged. In this embodiment, by arranging the second extension 422 between the filter device 213 and the transformer 212, on the one hand, heat on the filter device 213 and the transformer 212 may be synchronously conducted out by means of the second extension 422; on the other hand, the second extension 422 may function as an insulating structure to isolate the filter device 213 from the transformer 212 to ensure a safety distance between the filter device 213 and the transformer 212, such that the filter device 213 and the transformer 212 may be arranged closer to each other, for example, the filter device 213 and the transformer 212 may be stacked together or are arranged next to each other with the second extension 422 being located therebetween, thereby making the structure more compact, and reducing the size of the charging device 100. In some embodiments, the second extension 422 may be in a shape surrounding the transformer 212 or the filter device 213, such as, an L-shape shown in FIG. 4.

In some embodiments, the cover 43, for example, is a high-thermal-conductivity insulating component. That is, the cover 43 may be made from a high-thermal-conductivity insulating material. For example, the high-thermal-conductivity insulating material may be a composite of polycarbonate, graphite and a phosphonium flame retardant, where the concentration (i.e., mass fraction) of the polycarbonate is 70%-80%, the concentration of the graphite is less than 25%, the concentration of the phosphonium flame retardant is less than or equal to 5%, and the phosphonium flame retardant, for example, is a phosphate ester flame retardant. It is understandable that the cover 43 is not limited to the aforesaid high-thermal-conductivity insulating material and may be made from any material that have a high thermal conductivity and a good insulating property. The high-thermal-conductivity insulating material has extremely good thermal-conduction performance under a specific temperature condition and can transfer heat quickly, such that a quick thermal-conduction effect may be achieved by means of the cover 43.

In some embodiments, the first portion of the heat-exchange assembly 40 includes a high-thermal-conductivity insulating component. That is, the first portion of the heat-exchange assembly 40 may be made from a high-thermal-conductivity insulating material. For example, the thermally-conductive bracket 41 is made from a high-thermal-conductivity insulating material. Alternatively, the thermally-conductive extension 42 is made from a high-thermal-conductivity insulating material. This embodiment has no limitation in this aspect. In a case where the high-thermal-conductivity insulating material is selected, the first portion may be designed to conduct heat in the length direction, so as to achieve a better thermal-conduction effect. The thermally-conductive extension 42, for example, may be designed to conduct heat in a direction from the cover 43 to the target device 21 to be cooled, such that heat may be conducted onto the cover 43 more quickly.

In some other embodiments, the heat-exchange assembly 40 includes a metal part and an insulating part, and the insulating part insulates the metal part from the internal electronic unit 20. For example, the metal part may be wrapped with an insulating layer, or the insulating part is arranged on a side, closer to the internal electronic unit 20, of the metal part, such that the quick heat conduction is achieved by means of the thermal-conduction property of metal part, and the electrical insulation is achieved by means of the insulating part.

In some embodiments, the housing 10 includes an outer shell 12 and an inner shell 14, the inner shell 14 is arranged around the opening 15. The heat-exchange assembly 40 includes a thermally-conductive extension 42 extending from the second portion thereof into the internal chamber 13, and the thermally-conductive extension 42 is in contact with the inner shell 14. The inner shell 14 can absorb heat dissipated into the internal chamber 13 from the internal electronic unit 20, and the heat absorbed by the inner shell 14 is conducted by the thermally-conductive extension 42 to the second portion of the heat-exchange assembly 40 and is then conducted out of the internal chamber 13 via the second portion, such that the quantity of heat transferred through the outer shell 12 is reduced, thereby avoiding thermal discomfort on the hands when users touch the outer shell 12.

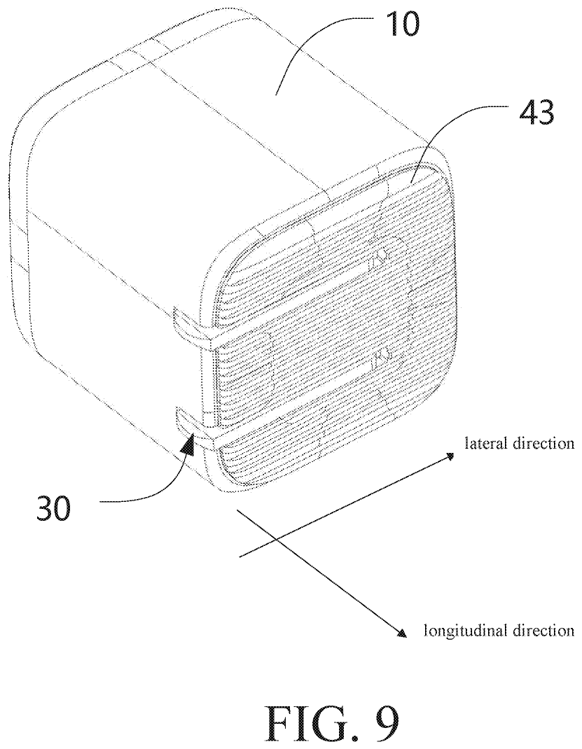

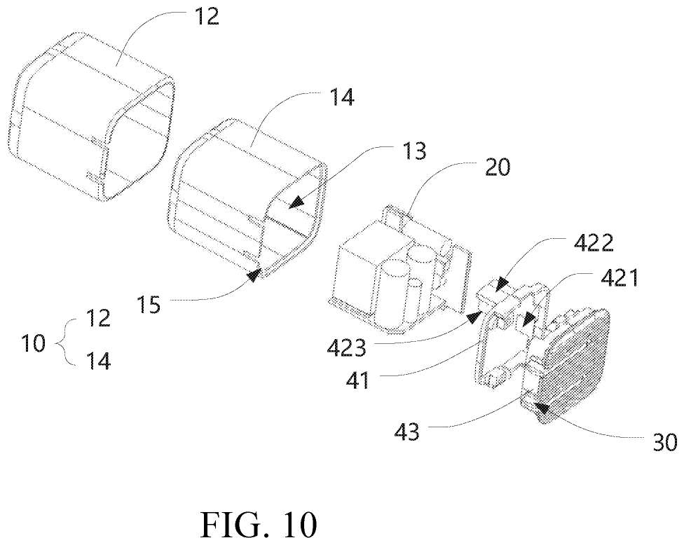

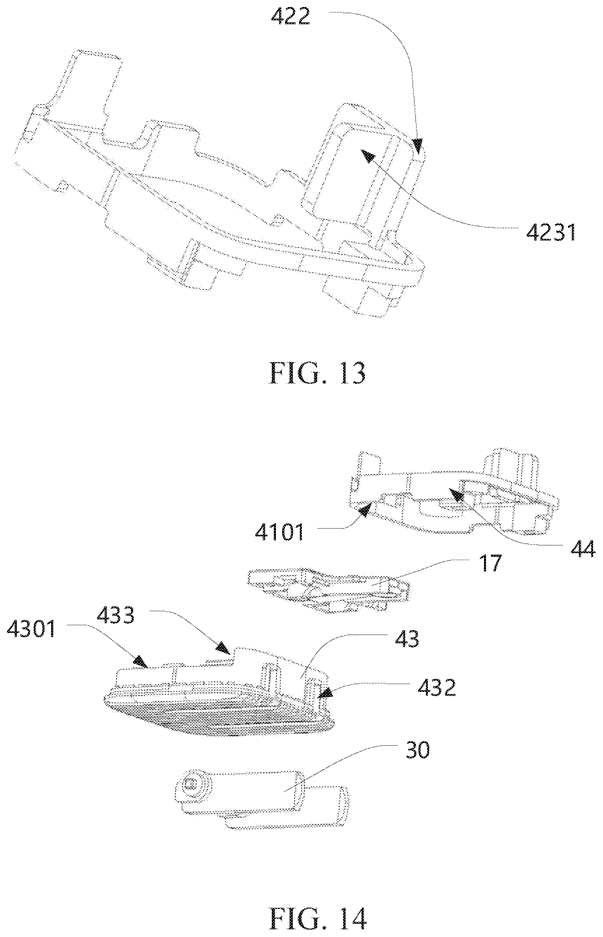

Referring to FIGS. 9-15, another embodiment of the present application provides a charging device 100. The charging device 100 in this embodiment is different from the charging device 100 in the above embodiment mainly in the structure of the thermally-conductive bracket 41. In this embodiment, the charging device 100, for example, includes a housing 10, a cover 43, a thermally-conductive bracket 41, an internal electronic unit 20 and plug pins 30. As shown in FIG. 10, the housing 10, for example, includes an outer shell 12 and an inner shell 14, the outer shell 12 is arranged around the inner shell 14, and the housing 10 comprises an internal chamber 13 and an opening 15 communicating with the internal chamber 13. In this embodiment, the internal chamber 13 is formed inside the inner shell 14, and the opening 15 is also formed in the inner shell 14. The cover 43 is connected to the housing 10, and the cover 43 may be connected to the housing 10 in a sealing manner to form the internal chamber 13. The thermally-conductive bracket 41 is connected to the cover 43 and located in the internal chamber 13. The internal electronic unit 20 is arranged in the internal chamber 13 and is in thermal-conduction with the thermally-conductive bracket 41. The plug pins 30 are arranged on the cover 43, and each of the plug pins 30 has an end electrically connected to the internal electronic unit 20 in the internal chamber 13, as well as an opposite end extending through the cover 43 and exposed out of a side, away from the thermally-conductive bracket 41, of the cover 43.

Specifically, the plug pins 30 are to be plugged to a socket to conduct current into the internal electronic unit 20. The internal electronic unit 20, for example, includes a power management circuit, components constituting the power management circuit, a circuit board for providing support and contacts for the power management circuit, an output interface for outputting current to an electronic product to be charged, and the like. When the charging device 100 provided by this embodiment is used for charging an electronic device to be charged, the plug pins 30 are plugged into a socket, and input current is regulated by the internal electronic unit 20 and then output via the output interface to the electronic product to be charged, so as to implement charging. During the charging process, since the thermally-conductive bracket 41 is in thermal-conduction connection with the internal electronic unit 20 and is connected to the cover 43, heat produced by the internal electronic unit 20 may be quickly conducted onto the cover 43 by means of the thermally-conductive bracket 41, that is, the heat produced by the internal electronic unit 20 may be quickly conducted out of the internal chamber 13. As shown in FIG. 14, receiving slots 432, configured for receiving the plug pins 30, are formed in a side, away from the internal chamber 13, of the cover 43, and the plug pins 30 are movably connected to the cover 43, such that after charging is completed, the plug pins 30, for example, may be received in the receiving slots 432, thereby facilitating storage of the charging device 100. The outer shell 12 may be made from a transparent material, the inner shell 14 may be made from a plastic material, the inner shell 14 may be selectively made from a transparent material or a non-transparent material, and the outer shell 12 is isolated from the internal electronic unit 20 by the inner shell 14.

In this embodiment, since the thermally-conductive bracket 41 is in thermal-conduction connection with the internal electronic unit 20 and is arranged on the cover 43, heat produced by the internal electronic unit 20 may be conducted out of the internal chamber 13 by means of the cover 43 connected to the thermally-conductive bracket 41, which is in thermal-conduction connection with the internal electronic unit 20, such that the problem of an unsatisfactory heat-dissipation effect of the charging device 100 with a small size is solved.

As shown in FIGS. 10-12, the thermally-conductive bracket 41 is provided with a first extension 421, and the first extension 421 extends towards the internal electronic unit 20 and is in thermal-conduction connection with the internal electronic unit 20. The internal electronic unit 20, for example, includes a target device 21 to be cooled, and the target device 21 to be cooled refers to an electronic component that produces a relatively large quantity of heat when the charging device 100 operates, such as a transformer, a capacitor, or a chip. The first extension 421 is in thermal-conduction connection with the target device 21 to be cooled, facilitating directional heat dissipation of the target device 21 to be cooled.

Further, the target device 21 to be cooled, for example, includes a first circuit board 22 and a rectifier chip 211, and the first circuit board 22 is connected to the cover 43. The rectifier chip 211 is arranged on the first circuit board 22, and the first extension 421 extend to the rectifier chip 211 and is in thermal-conduction connection with the rectifier chip 211. In the present application, the internal electronic unit 20 in the charging device 100 will produce heat when operating, some electronic elements will produce a relatively large quantity of heat in operation, and these electronic elements are called as high-heat-generation electronic devices. The rectifier chip 211 in the present application is a high-heat-generation electronic device. When the charging device 100 operates, the plug pins 30 are plugged into a socket to conduct alternating current into the internal electronic unit 20, and then the rectifier chip 211 rectifies the alternating current to covert the input alternating current into direct current. By means of the first extension 421 that extends to contact the rectifier chip 211, heat may be quickly conducted from the rectifier chip 211 to the cover 43 by means of the first extension 421, such that the purpose of directional heat dissipation is fulfilled.

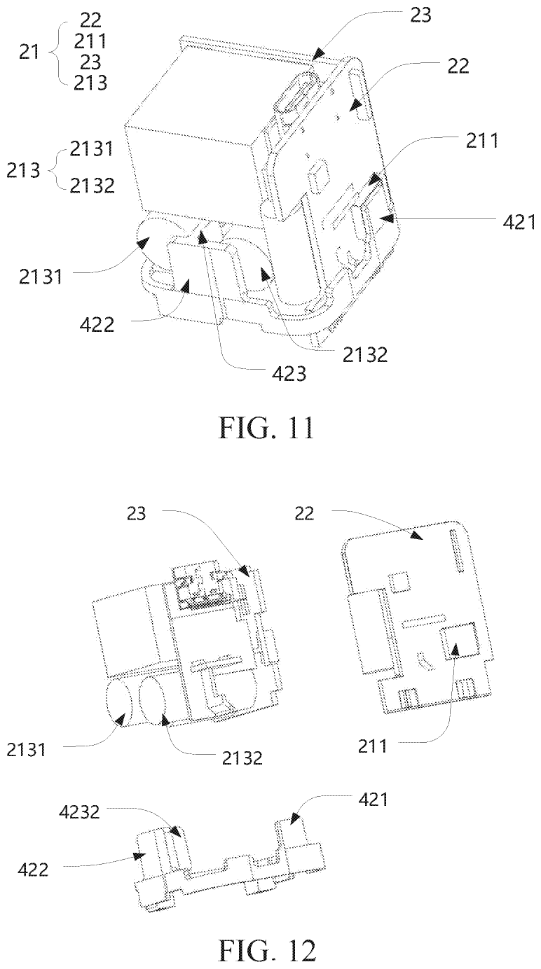

Specifically, as shown in FIGS. 11 and 12, the rectifier chip 211 is arranged on a side, close to an inner wall of the housing 10, of the first circuit board 22, and the first extension 421 extends to the rectifier chip 211 and is in contact connection with the rectifier chip 211. The contact surface, in contact with the rectifier chip 211, of the first extension 421 is parallel with the first circuit board 22. By arranging the rectifier chip 211 on the side, close to the inner wall of the housing 10, of the first circuit board 22, heat produced by the rectifier chip 211 can be conducted out of the inner chamber more easily by means of the thermally-conductive bracket 41, thereby fulfilling the purpose of further directional heat dissipation.

Further, the target device 21 to be cooled, for example, further includes a second circuit board 23 and a filter device 213. The second circuit board 23 is connected to the first circuit board 22, and the second circuit board 23 is also connected to the cover 43. By means of the first circuit board 22 and the second circuit board 23, the internal electronic unit 20 is integrated into a whole to be assembled on the cover 43 and be in thermal-conduction connection with the thermally-conductive bracket 41. Moreover, by arranging the first circuit board 22 and the second circuit board 23, the thermally-conductive bracket 41 may have a larger contact area with the first circuit board 22 and the second circuit board 23. The filter device 213 is arranged on the second circuit board 23. The thermally-conductive bracket 41 is further provided with a second extension 422, and the second extension 422 extends to an outer surface of the filter device 213. The filter device 213, for example, is one of circuit components for converting a high-voltage power supply in the charging device 100. By means of the second extension 422 that extends to the outer surface of the filter device 213, heat produced by the filter device 213 may be quickly conducted to the cover 43 and dissipated out of the internal chamber 13.

In some embodiments, the first circuit board 22 and the second circuit board 23 may be arranged perpendicular to each other, such that the structure of the internal electronic unit 20 is more compact. The inner shell 14 has a rectangular or square shape, and comprises a pair of first side walls parallel with each other and a pair of second side walls parallel with each other. The first circuit board 22 is parallel with one of the first side wall and the second side wall and the second circuit board 23 is parallel with the other of the first side wall and the second side wall.

Furthermore, as shown in FIGS. 11 and 12, the filter device 213 includes a first capacitor 2131 and a second capacitor 2132. The first capacitor 2131 and the second capacitor 2132 are arranged on the second circuit board 23 at an interval. The thermally-conductive bracket 41 further includes a third extension 423 which extends from the second extension 422 into a gap between the first capacitor 2131 and the second capacitor 2132. The first capacitor 2131 and the second capacitor 2132, for example, may be electrolytic capacitors in a circuit for converting a high-voltage power supply in the charging device 100. In the present application, by arranging the third extension 423 in the gap between the first capacitor 2131 and the second capacitor 2132, heat produced by the first capacitor 2131 and the second capacitor 2132 may be quickly conducted out of the internal chamber 13, thereby fulfilling the purpose of quick heat dissipation.

Furthermore, as shown in FIGS. 11-13, the third extension 423 and the second extension 422 are perpendicular to each other. The third extension 423 has a first surface 4231 and a second surface 4232 which are opposite to each other. The first surface 4231 is in contact connection with a side surface of the first capacitor 2131, the second surface 4232 is in contact connection with a side surface of the second capacitor 2132, and the second extension 422 is in contact connection with end surfaces of the first capacitor 2131 and the second capacitor 2132. By designing the second extension 422 and the third extension portion 423 to be in contact with the surfaces of the first capacitor 2131 and the second capacitor 2132 respectively, the purpose of further heat dissipation and conduction of the filter device 213 is fulfilled.

As shown in FIG. 14, the thermally-conductive bracket 41 includes a first end surface 4101 adjacent to the cover 43, the cover 43 includes a second end surface 4301 corresponding to the first end surface 4101, and the first end surface 4101 is in contact connection with the second end surface 4301. Since the first end surface 4101 is in contact connection with the second end surface 4301, the thermally-conductive bracket 41 may be aligned with and fixedly connected to the cover 43.

In some embodiments, the thermally-conductive bracket 41 is of a ring structure. Specifically, the thermally-conductive bracket 41 comprises a ring-shaped base connected to the cover 30 and the thermally-conductive extensions 421/422 extending from the ring-shaped base in a direction away from the cover 43. The thermally-conductive bracket 41 and the cover 43 are separated formed and assembled together.

By designing the thermally-conductive bracket 41 into a ring structure, heat absorbed by the thermally-conductive bracket 41 may be conducted in the circumferential direction to achieve a quick heat distribution effect, such that thermal discomfort on the hands caused by an excessively high local temperature is avoided.

The thermally-conductive bracket 41 and the cover 43 are separately formed. Thus, the thermally-conductive bracket 41 may be produced separately by injection moulding, thereby reducing the complexity of an injection mould, and improving production efficiency. In some embodiments, the thermally-conductive bracket 41 may be fixedly connected to the cover 43 by an adhesive, ultrasonic welding, or the like. In other embodiments, the thermally-conductive bracket 41 is detachably connected to the cover 43, such that assembly and disassembly between the thermally-conductive bracket 41 and the cover 43 are facilitated. In addition, when the charging device 100 is upgraded (i.e., when the arrangement of the internal electronic unit 20 is changed), only the corresponding thermally-conductive bracket 41 needs to be changed, thereby reducing the production cost of the charging device 100.

Further, as shown in FIG. 14, a protrusion 44 protruding towards the cover 43 is arranged on the thermally-conductive bracket 41, the protrusion 44 is located on the first end surface 4101, a groove 433 is correspondingly formed in the second end surface 4301, and the protrusion 44 is connected to the groove 433. In this embodiment, the thermally-conductive bracket, for example, is a ring-shaped bracket which is hollowed out in the middle thereof. The internal electronic unit 20 may be arranged in a hollowed-out section of the ring-shaped bracket such that the thermally-conductive bracket 41 surrounds the outer side of the internal electronic unit 20. Since the thermally-conductive bracket 41 is ring-shaped, the first end surface 4101, in contact with the cover 43, of the thermally-conductive bracket 41 is similar to a hollowed-out rectangle, with a constant heat conduction area. By arranging the protrusions 44 on the thermally-conductive bracket 41, the contact area between the thermally-conductive bracket 41 and the cover 43 is enlarged, that is, the thermal-conduction connection area is enlarged, such that the thermally-conductive bracket 41 may transfer more heat to the cover 43, and then the heat is dissipated out from the cover 43. In addition, the arrangement of the protrusion 44 and the groove 433 facilitates assembly of the thermally-conductive bracket 41 and the cover 43 and achieves an anti-misassembly effect to avoid a failure of assembly.

In some embodiments, as shown in FIG. 15, the outer surface of the thermally-conductive bracket 41 inclines from the periphery of the thermally-conductive bracket 41 to the center of the thermally-conductive bracket 41, and the outer surface of the cover 43 also inclines from the periphery to the center. In this way, the thermally-conductive bracket 41 and the cover 43 may be assembled with the housing 10 more easily, and the thermally-conductive bracket 41 may be assembled in the internal chamber 13 more easily.

The thermally-conductive bracket 41 and the cover 43, for example, may be thermally conductive components. That is, the thermally-conductive bracket 41 and the cover 43 may be made from a thermally conductive material. The thermally conductive material may be thermally conductive materials in the prior art. For example, the thermally conductive material is a material with an outstanding thermal-conduction property and can transfer heat extremely quickly, such that a quick thermal-conduction effect is achieved by means of the thermally-conductive bracket 41 and the cover 43.

Furthermore, as shown in FIG. 14, a fixing bracket 17 is arranged on a side, close to the internal chamber 13, of the cover 43, and the ends, electrically connected to the internal electronic unit 20, of the plug pins 30 are connected to the fixing bracket 17. Preferably, the fixing bracket 17 is disposed between the cover 43 and the thermally-conductive bracket 41 in the longitudinal direction of the housing 10.

In some embodiments, the outer peripheral surface of the thermally-conductive bracket 41 is flush with the outer peripheral surface of the cover 43.

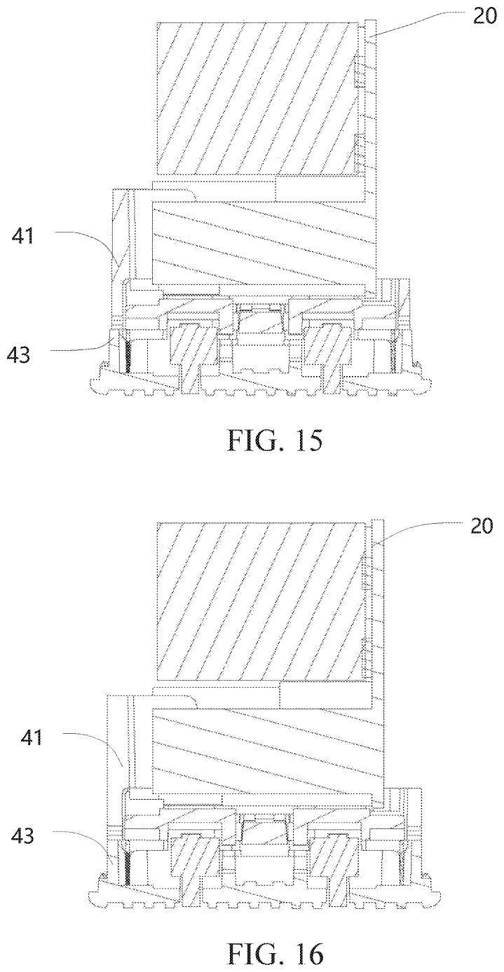

Specifically, as shown in FIG. 16, the outer peripheral surface of the thermally-conductive bracket 41 is flush with the outer peripheral surface of the cover 43. That is, a smooth transition is formed between the outer peripheral surfaces of the thermally-conductive bracket 41 and the cover 43. By designing the outer side surface of the thermally-conductive bracket 41 to be flush with the outer side surface of the cover 43, assembly of the thermally-conductive bracket 41 and the cover 43 is facilitated. The thermally-conductive bracket 41 and the cover 43 may be assembled together first, and then a combination of the thermally-conductive bracket 41 and the cover 43 is assembled in the internal chamber 13, such that assembly efficiency is improved.

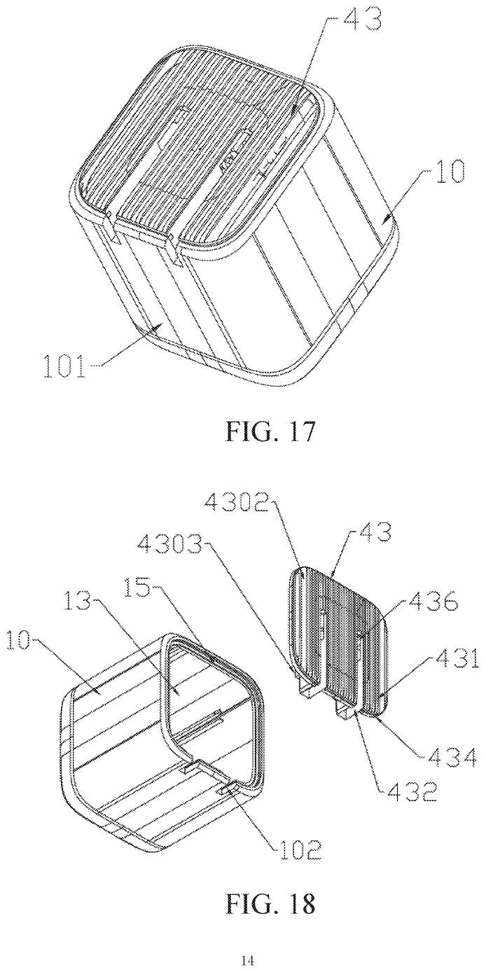

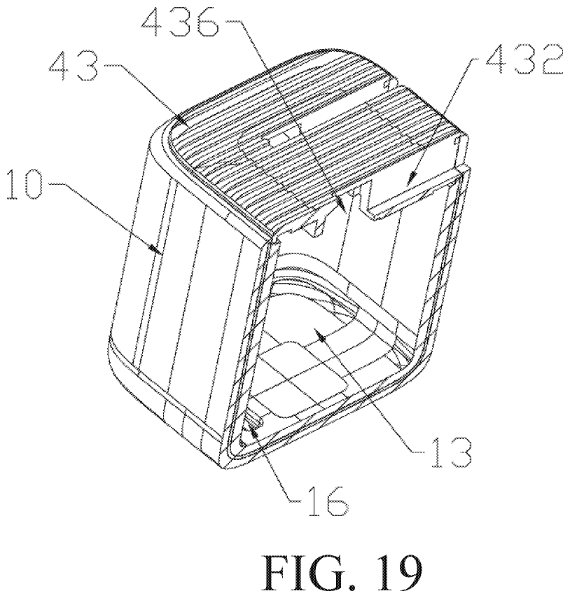

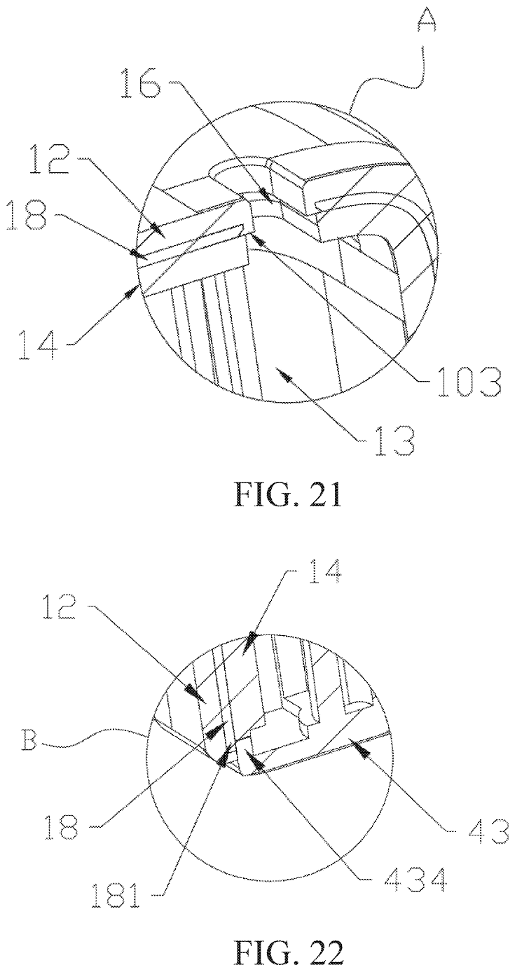

Refer to FIGS. 17 to 22 and FIGS. 28 to 30, a further another embodiment of the present invention provides an electronic device casing 101 for a charging device 100. The electronic device casing 101 includes a housing 10 and a cover 43. The housing 10 comprises, from innermost to outermost, an inner shell 14, a thermal spreading layer 18, and an outer shell 12. The housing 10 comprises an internal chamber 13 defined inside the inner shell 14. The internal chamber 13 is configured to accommodate the internal electronic unit 20 which comprises one or more electronic components. The housing 10 includes an opening 15 in communication with the internal chamber 13 to provide access for the internal electronic components 20 to enter into the internal chamber 13. The opening 15 is located at the side of the housing 10 adjacent to the cover 43, forming an aperture that connects the internal chamber 13w ith the external environment. The cover 43 is mounted in the opening 15 and connected to the housing 10, thereby covering the internal chamber 13 of the housing 10. In some optional embodiments, the side walls of the cover 43 may be sealingly connected to the inner walls of the opening 15 by ultrasonic welding.

Specifically, the housing 10 has a multi-layer composite structure consisting, from inside to outside, of the inner shell 14, the thermal spreading layer 18, and the outer shell 12. The inner shell 14 serves as the inner housing/layer of the electronic device casing 101 and may be an insulating inner shell. The outer shell 12 serves as the outer protective housing/layer of the electronic device casing 101 and may be an insulating outer shell. The thermal spreading layer 18 is located between the inner and outer shells. The cover 43 functions as an end cover of the electronic device casing 101. During assembly of the charging device 100, the internal electronic unit 20 is inserted through the opening 15 into the internal chamber 13 and connected to the housing 10. Specifically, the internal electronic unit 20 is securely fixed to the inner shell 14. Subsequently, the cover 43 is connected to both the housing 10 and the electric components of the internal electronic unit 20. The assembly of the charging device 100 is completed.

The internal electronic unit 20 include heat-generating electronic components such as transformers, rectifier chips, high-voltage electrolytic capacitors, power chips, and a first circuit board 22. Heat generated by these components during operation dissipates outward via two pathways. Along the first pathway, heat is initially transferred to the inner shell 14, then to the thermal spreading layer 18 which evenly transfer the heat to the outer shell 12, and finally transferred to the environment via the outer shell 12. Along the second pathway, part of the heat is directly transferred to the cover 43 which dissipates it directly to the environment and the other part of the heat from this pathway is transferred to the thermal spreading layer 18 of the housing 10 from the cover 43 since the cover 42 is mechanically and thermally conductive connected to the housing 10. Similar to the first pathway, the thermal spreading layer 18 uniformly distributes the other part of the heat to the outer shell 12 which then dissipates the heat into the environment. Thus, through cooperatively operation of the housing 10 and the cover 43, heat generated by the heat-generating electronic components of the internal electronic unit 20 is efficiently and rapidly dissipated to the external environment, which significantly enhances the overall thermal dissipation capability of the charging device 100, lowers the electrical safety risks of the charging device 100, extends the service life of the charging device 100, and enables higher power density development of the charging device 100. The thermal spreading layer 18 can also be called as heat equalization layer or thermal equalization layer.

In one optional embodiment, the thicknesses of both the inner shell 14 and the outer shell 12 are greater than that of the thermal spreading layer 18. The inner shell 14 with a relatively large thickness ensures sufficient insulation between the electric components and the thermal spreading layer 18 while providing a stable support for internal electric components. As the outermost protective layer, the outer shell 12 with a relatively large thickness is capable of effectively resisting external physical impacts and environmental degradation, thereby prolonging the lifespan of the charging device 100. The thermal spreading layer 18 possesses high thermal conductivity, enabling efficient lateral heat distribution. Meanwhile, the inner shell 14 and outer shell 12 with increased thickness provides additional thermal capacitance, slowing the rate of temperature rise and resulting in a more uniform surface temperature distribution in the housing. At the same time, excessive volume of the electronic device casing 101 is avoided.

In one optional embodiment, at least a portion of the inner shell 14 is made of a first thermal-conductive material whose thermal conductivity is greater than that of the outer shell 12 but less than that of the thermal spreading layer 18. The thermal conductivity of the first thermal-conductive material may range from 0.5 W/(m·K) to 3.0 W/(m·K), which is higher than that of conventional plastics (typically around 0.2 W/(m·K)). This enables the inner shell 14 to rapidly absorb heat from the internal electronic unit 20 and transfer the heat to the thermal spreading layer 18. If the thermal conductivity of the first material falls below 0.5 W/(m·K), its heat conduction efficiency will be close to that of conventional plastic material and fail to achieve efficient thermal conduction effect. If the thermal conductivity of the first material exceeds 3.0 W/(m·K), to balance both thermal conduction property and electrical insulation property, conventional insulating thermal fillers in the first material such as alumina or magnesium oxide need be replaced with high-conductivity fillers like boron nitride to significantly enhance the plastic's thermal conductivity. Plastics with standard fillers (e.g., alumina or magnesium oxide) typically have a thermal conductivity of about 1.0-2.0 W/(m·K), while plastics with boron nitride can achieve over 3.0 W/(m·K). However, the use of boron nitride will lead to a substantial increase in the material cost per unit. The material cost of boron nitride is usually several times to more than ten times that of conventional fillers.

In this embodiment, the entire inner shell 14 is made of the first thermal-conductive material, which may specifically be a modified plastic material (e.g., plastic containing thermal-conductive fillers). In an alternative embodiment, the inner shell 14 is made of a high-temperature-resistant, flame-retardant plastic material, in which case the thermal conductivity of the inner shell is equal to or close to that of the outer shell 12.

In one optional embodiment, the thermal spreading layer 18 is made of a high thermal-conductive material, such as metal, graphene, or composite materials (e.g., carbon/carbon composite material or metal matrix composite material). The thermal spreading layer 18 covers the entire outer surface of the inner shell 14 facing away from the internal chamber 13 such that heat can be transferred from the inner shell 14 to the thermal spreading layer 18 quicky, thereby preventing heat accumulation on the inner shell 14 or within the internal chamber 13, which could otherwise cause localized overheating of the housing 10. In this embodiment, the thermal spreading layer 18 is made of metal, such as aluminum or copper. Aluminum has a thermal conductivity of 120-240 W/(m·K) and copper has a thermal conductivity of 400 W/(m·K).

In one optional embodiment, the thermal spreading layer 18 made of metal material undergoes an anodizing process to form an insulating protective film on its surface. This preserves the lateral heat diffusion capability of the thermal spreading layer 18 while ensuring electrical safety.

In one optional embodiment, the outer shell 12 is made of a transparent material, such as transparent polycarbonate (PC). The outer shell 12 encases the outer surface of the thermal spreading layer 18, forming the final configuration of the electronic device casing 101. The outer shell 12 as the outermost layer of the electronic device casing 101 provides both aesthetic appearance and effective protection. The outer shell 12 offers excellent light transmittance and scratch resistance, allowing the decorative patterns on the underlying thermal spreading layer 18 to be clearly visible. For example, when the thermal spreading layer 18 is made of metal, surface treatments such as brushed metal finishes can be applied to the thermal spreading layer 18 to create distinctive metallic textures while maintaining the overall texture of the electronic device casing 101. The thermal conductivity of the outer shell 12 is approximately 0.2 W/(m·K).

In one optional embodiment, the housing 10 is formed through a two-step overmolding process (i.e., a two-stage injection molding process). First, the thermal spreading layer 18 is integrally molded with one of the inner shell 14 and the outer shell 12 via the first overmolding step, forming a semi-finished component. This semi-finished component is then further integrally molded with the other of the inner shell 14 and outer shell 12 in the second overmolding step to form the housing 10. Preferably, the outer shell 12 is made of semi-transparent polycarbonate material, and the thermal spreading layer 18 is made of metal. The inner shell 14, thermal spreading layer 18, and the outer shell 12 are manufactured using the overmolding processes such that tight connections are established between the insulation layers and the thermal spreading layer 18 and effective thermal conduction is achieved between the inner/outer shell 14/12 and the thermal spreading layer 18.

The tight connection between the cover 43 and the housing 10 results in an efficient heat transfer between the thermal spreading layer 18 and the cover 43. The opening 15 serves as a concentrated outlet for internal hot air and thermal radiation, where heat tends to accumulate most easily. The cover 43 is mounted in the opening 15 such that accumulated heat and heat conducted from the thermal spreading layer 18 can be rapidly dissipated through the cover 43, which effectively reduces the internal temperature of the electronic device casing 101, prevents localized overheating, avoids the formation of hot spots, and also improves the product's safety reliability and user tactile comfort.

As shown in FIGS. 17 to 19, in one optional embodiment, the surface 4302 of the cover 43, opposite to the internal chamber 13, is provided with a plurality of fins 431. The fins 431 function as heat-dissipating fins, increasing the surface area for heat dissipation and improving cooling efficiency of the cover 43. The protruding direction of the fins 431 aligns with the orientation of the opening 15 of the housing 10, establishing an efficient thermal conduction path from the thermal spreading layer 18 to the external air.

In one optional embodiment, the cover 43 is made of a second thermally conductive material, which may be the same as or different from the aforementioned first thermally conductive material. The thermal conductivity of the cover 43 is higher than that of the outer shell 12. As a result, significantly more heat is dissipated into the environment through the cover 43 than through the first pathway, keeping the surface temperature of the outer shell 12 relatively low. During high-load operation of the charging device 100, the temperature of the outer surface of the housing 10 approaches or slightly exceeds human body temperature, thereby enhancing user experience. The fins 431 have a highly efficient fin structure with alternating protrusions and grooves. The protruding direction of the fins 431 aligns with the orientation of the opening 15 on the housing 10, enabling efficient directional conduction of heat from the internal chamber 13 to the distal ends of the fins 431 on the cover 43, followed by rapid dissipation through the fins 432 with an increased surface area.

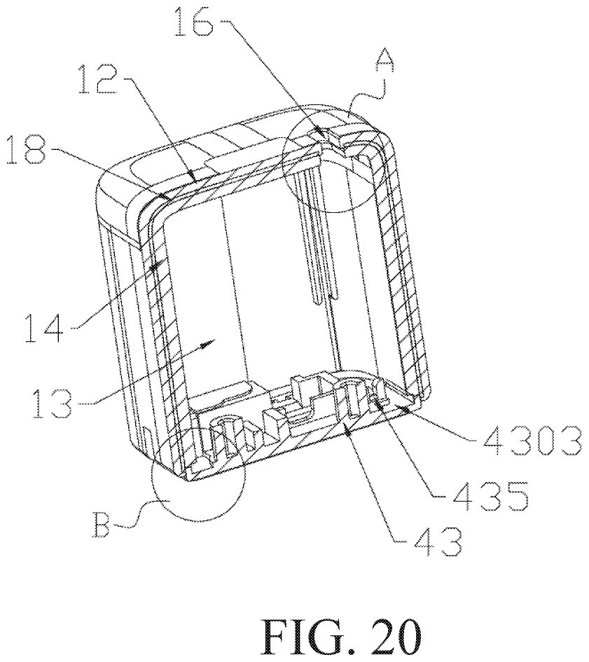

As illustrated in FIGS. 20 and 22, the cover 43 comprises a first connecting portion 434 extending from the edge thereof. The first connecting portion 434 extends into the internal chamber 13 in a direction opposite to the protruding direction of the fins 431. The first connecting portion 434 is engaged with an inner surface of the internal chamber 13 to thereby secure the cover 43 to the housing 10. The thermal spreading layer 18 includes a second connecting portion 181 located adjacent to the opening 15. The end of the outer shell 12 adjacent to the opening 15 is bent toward the geometric center of the opening 15 to form a first bent section 121. The geometric center of the opening 15 refers to its central point. For example, if the opening 15 is square-shaped, the geometric center of the opening 15 is the intersection of two diagonals of the square opening; if the opening 15 is circular, the geometric center of the opening 15 is the center of the circle opening. The first bent section 121 covers the end face of the second connecting portion 181. The first connecting portion 434 connects to the side of the second connecting portion 181 facing the internal chamber 13, the first bent section 121, and the end of the inner shell 14 adjacent to the opening 15. Specifically, the end face of the first connecting portion 434 abuts against the end face of the second connecting portion 181 and the side face of the first connecting portion 434 abuts against the inner side faces of the second connecting portion 181 and the bent section 121. Thus, the contact area between the cover 43 and the housing 10 is increased, thereby enhancing the stability of the connection between the cover 43 and the housing 10. Furthermore, the contact area between the thermal spreading layer 18 and the cover 43 is also increased, thereby improving the rate of heat transfer between the thermal spreading layer 18 and the cover 43. When the temperature on the cover 43 becomes too high, most of the heat of the cover 43 dissipates directly into the surrounding environment, while a portion of the heat is transferred through the first connecting part 434 and the second connecting part 181 to the thermal spreading layer 18. The second connecting part 181 spreads this portion of the heat to other areas of the thermal spreading layer 18, which subsequently transfers the heat to the outer shell 12, allowing the heat to be dissipated into the external environment. Thus, the temperature on the cover 43 can remain stable. Furthermore, the first connecting part 434 cooperates with the first bent section 121 and the inner shell 14 to enclose and seal the second connecting part 181. This not only prevents the thermal spreading layer 18 from being exposed, thus maintaining aesthetic appearance, but also prevents moisture in the external environment from coming into contact with the thermal spreading layer 18 to cause corrosion. Additionally, outside air is stopped from entering the space between the outer shell 12 and the thermal spreading layer 18, avoiding the formation of air bubbles that could impair the appearance. Moreover, the second connecting part 181 covers the joint area between the first connecting part 434 and the inner shell 14, preventing the seam from being exposed and ensuring visual integrity.

Specifically, the end of the thermal spreading layer 18 adjacent to the opening 15 extends axially beyond the inner shell 14 to form the second connecting part 181 such that the second connecting part 181 has one side facing the internal chamber 13, which is exposed within the internal chamber 13. The first connecting part 434 of the cover 43 extends inward from the periphery of the cover 43 into the internal chamber 13, and the side face of the first connecting part 434 is in firmly contact with the side face of the second connecting part 181 facing the internal chamber 13.

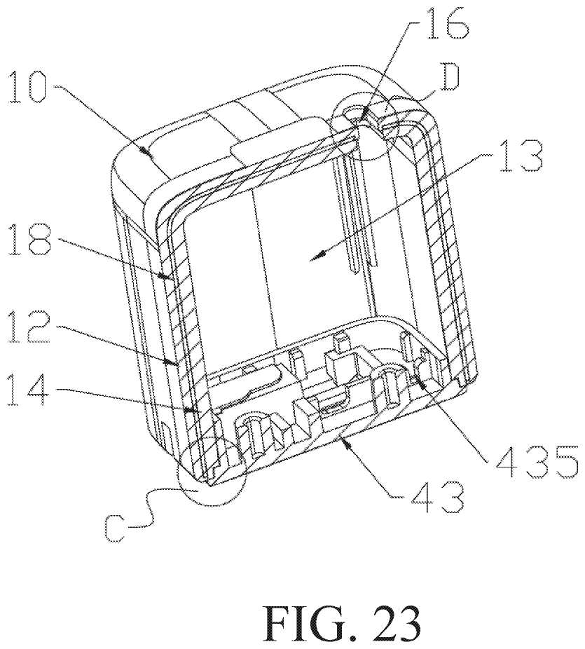

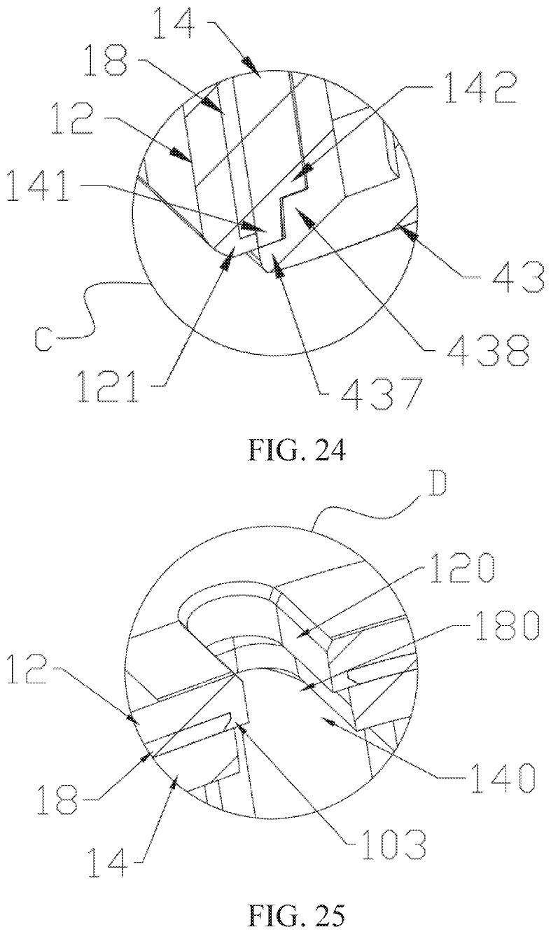

As shown in FIGS. 23 and 24, alternatively, the cover 43 is connected to the inner shell 14 to enable heat conduction between the cover 43 and the housing 10. The end of the outer shell 12 adjacent the opening 15 is bent toward the geometric center of the opening 15 to form the first bent section 121. The first bent section 121 covers the end face of the thermal spreading layer 18 adjacent to the opening 15 and connects to the side wall of the inner shell 14 adjacent to the opening 15. Thus, the edges of the inner shell 14 and the outer shell 12 are connected to each other to thereby enclose the edge of the thermal spreading layer 18 such that the thermal spreading layer 18 is fully enclosed by the inner shell 14 and the outer shell 12. Specifically, the end of the inner shell 14 near the opening 15 includes a third connecting part 141 and a fourth connecting part 142, the third connecting part 141 is located close to the thermal spreading layer 18, and the fourth connecting part 142 is located away from the thermal spreading layer 18. The cover 43 comprises a fifth connecting part 437 and a sixth connecting part 438 that protrude toward the internal chamber 13, and the thickness of the fifth connecting part 437 is less than that of the sixth connecting part 438. The lower end surface of the third connecting part 141 near the opening 15 abuts against the upper end surface of the fifth connecting part 437 and the lower end surface of the fourth connecting part 142 near the opening 15 abuts against the upper end surface of the sixth connecting part 438, the outer side surface of the sixth connecting part 438 is closely connected to the inner side surface of the third connecting part 141, and the inner side surface of the third connecting part 141 abuts the first bent section 121.

Specifically, along the axial direction of the opening 15, the third connecting part 141 extends axially beyond the fourth connecting part 142 such that the lower end surfaces of the third connecting part 141 and the fourth connecting part 142 are at different levels in the axial direction of the opening 15. The connection between the third connecting part 141 and the fourth connecting part 142 results in a stepped configuration of the lower end surface of the inner shell 14, thereby increasing the surface area of the lower end surface of the inner shell 14. The upper end surfaces of the fifth connecting portion 437 and the sixth connecting portion 438 are at different levels in the axial direction of the opening 15. The Connection of the fifth connecting portion 437 and the sixth connecting portion 438 results in a stepped configuration of the upper end surface of the inner shell 14 extending into the internal chamber 13, thereby increasing the surface area of t he upper face of the cover 43 extending into the internal chamber 13. The cover 43 is connected to the inner shell 14. Specifically, the lower end surface of the third connecting portion 141 is in contact with the upper end surface of the fifth connecting portion 437, the lower end surface of the fourth connecting portion 142 is in contact with the upper end surface of the sixth connecting portion 438, and the outer side surface of the sixth connecting portion 438 is in contact with the inner side surface of the third connecting portion 141. Thus, the contact area between the inner shell 14 and the cover 43 is increased, improving thermal conductivity efficiency.

The side surface of the third connecting portion 141 is in contact with the first bent section 121, thereby enclosing the thermal spreading layer 18 between the inner shell 14 and the outer shell 12. Thus, the inner shell 14 and outer shell 12 are integrated as a single unit, fully encapsulating the thermal spreading layer 18 between the inner shell 14 and outer shell 12. This eliminates the poor adhesion issues caused by material differences between the thermal spreading layer 18 and the inner shell 14/outer shell 12, and prevents the thermal spreading layer 18 from being exposed t o affect aesthetics and come into contact with ambient moisture to cause corrosion. In addition, this prevents air bubbles from being trapped between the thermal spreading layer 18 and the inner/outer shells 14/12, which would otherwise degrade heat transfer performance and mar the product appearance.

This technical solution significantly increases the contact area between the cover 43 and the inner shell 14, enhancing the rate of heat transfer from the cover 43 to the outer shell 12, while also improving the mechanical connection stability between the cover 43 and the housing 10. When the temperature on the cover 43 becomes too high, most of the heat dissipates directly to the environment through the exposed surface of the cover 43. The remaining heat is transferred from the fifth connecting part 437 and the sixth connecting part 438 to the third connecting part 141 and the fourth connecting part 142 respectively. Some of the remaining heat transfers from the third connecting part 141 to the first bending section 121 and then to the outer shell 12, ultimately dissipating into the environment. Another portion of the remaining heat transfers from the inner shell 14 to the thermal spreading layer 18, and subsequently dissipates through the outer shell 12 to the environment. Thus, the cover 43 can be maintained at a stable temperature and localized overheating is avoided.

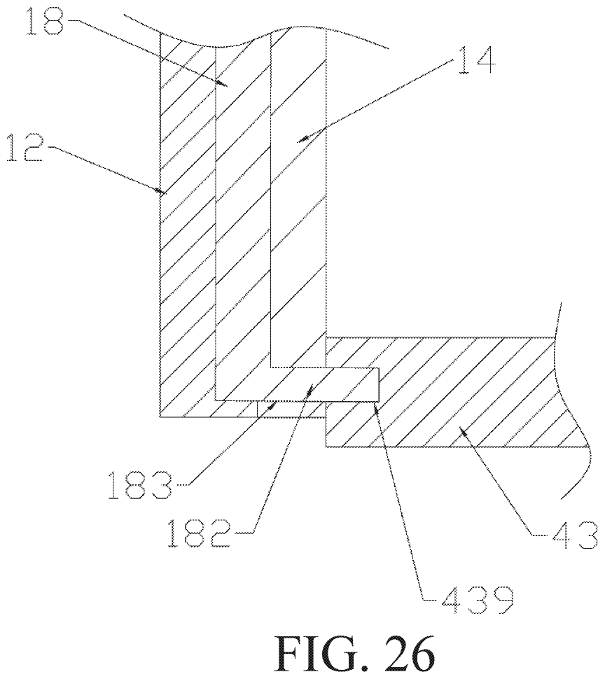

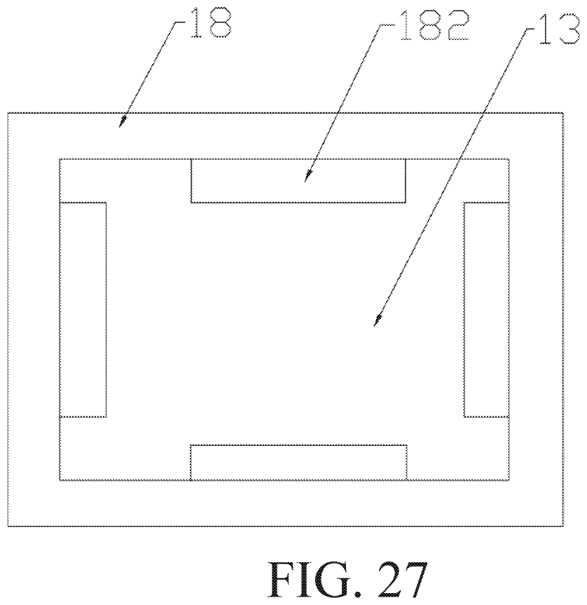

As shown in FIGS. 26 and 27, another implementation way is applied for connecting the cover 43 to the housing 10. The thermal spreading layer 18 comprises multiple second bent sections 182 formed at one end thereof adjacent to the opening 15. The second bent sections 182 extend toward the internal chamber 13. As shown in FIG. 27, the multiple second bent sections 182 are spaced circumferentially around the opening 15, with a part of either the inner shell 14 and/or the outer shell 12 positioned between adjacent second bent sections 182. That is, the spaces between any two adjacent second bent sections 182 are filled by extensions of the inner shell 14 and/or the outer shell 12. The inner shell 14 includes multiple third channels 183 corresponding to the second bent sections 182 in a one-to-one correspondence. The cover 43 has multiple insertion holes 439 each of which is aligned with a corresponding one of the third channels 183. Each second bent section 182 extends through the corresponding third channel 183 to be inserted into the corresponding insertion hole 439, thereby forming a fixed connection with the cover 43. Specifically, the second bent section 182 may be fixed to the cover 43 via welding or crimping or pressing.

In the circumferential direction of the opening 15, the multiple second bent sections 182 are arranged radially. Each second bent section 182 passes through one corresponding third channel 183 of the inner shell 14 into the internal chamber 13, and the distal end, away from the thermal spreading layer 18, of each second bent section 182 is inserted into one corresponding insertion hole 439 of the cover 43, thereby building both mechanical locking and thermal conduction connections. The contact area and connection strength between the thermal spreading layer 18 and the cover 43 are increased through the plug-in connection formed by multiple second bent sections 182 and corresponding insertion holes 439 in the cover 43, thereby significantly improving heat transfer efficiency between the thermal spreading layer 18 and the cover 43. Furthermore, the reliability of the connection between the cover 43 and the housing 10 is increased, providing good resistance to vibration and impact. One part of heat absorbed by the cover 43 dissipates directly into the environment and the other part of heat absorbed by the cover 43 is rapidly conducted through multiple second bent sections 182 to various regions of the thermal spreading layer 18. Heat transferred from the second bent sections 182 is evenly distributed via lateral thermal conduction within the thermal spreading layer 18 and finally dissipated into the environment through the outer shell 12, ensuring uniformity and stability in the overall temperature distribution of the electronic device casing 101.

Moreover, the spaces between adjacent second bent sections 182 are filled by extensions of the inner shell 14 and/or outer shell 12 such that the thermal spreading layer 18 and the multiple second bent sections 182 are completely enclosed and isolated from electrical components inside the internal chamber 13, providing a complete insulation protection for the thermal spreading layer 18 and the multiple second bent sections 182.

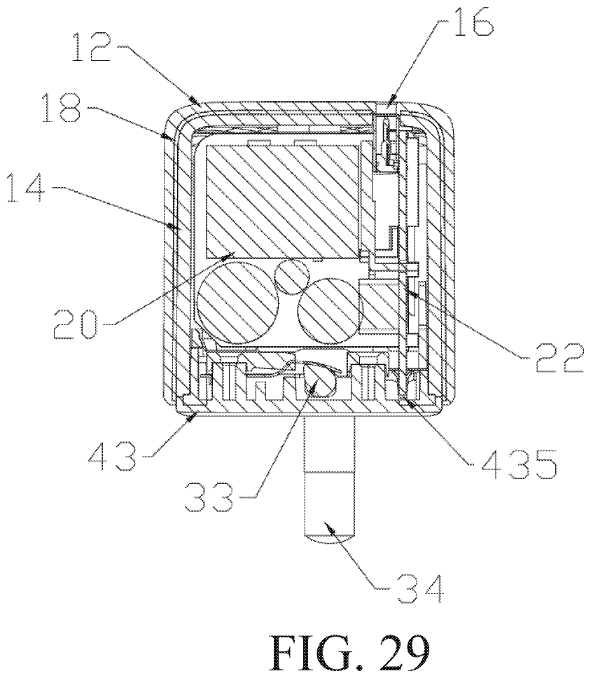

In one optional embodiment, as shown in FIGS. 20 and 29, the end surface 4303 of the cover 43 adjacent to the internal chamber 13 is connected to the first circuit board 22 of the internal electronic unit 20. The end surface 4303 of the cover 43 is provided with a locking slot 435 configured to receive one end of the first circuit board 22, enabling the cover 43 to connect with one end of the first circuit board 22. Heat generated by the first circuit board 22 is directly transferred to the cover 43, thereby shortening the heat conduction path. Furthermore, the first circuit board 22 is engaged in the locking slot 435 to thereby be connected to the cover 43, which enhances the connection reliability between the cover 43 and the internal electronic unit 20.

In one optional embodiment, as shown in FIGS. 20 and 29, other electric components of the internal electronic unit 20 are in contact with the end surface 4303 of the cover 43, further reducing the heat conduction path and improving the heat dissipation efficiency of the charging device 100.

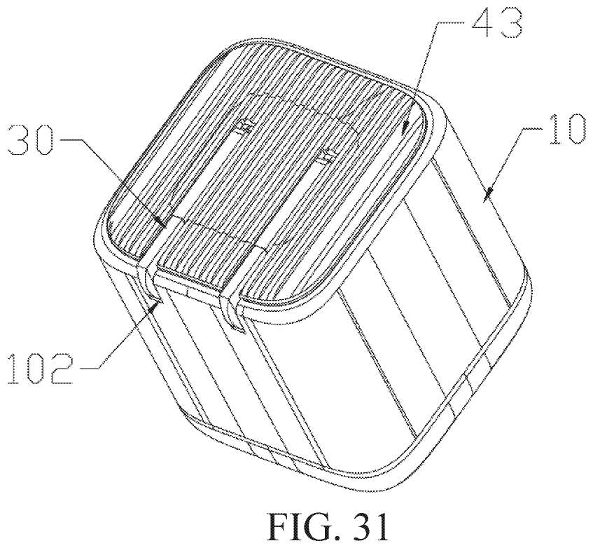

As illustrated in FIGS. 18, 19, and 28 to 32, in one optional embodiment, the charging device 100 includes plug pins 30 for electrical connection with an external socket. One end of each plug pin 30, which is located inside the internal chamber 13, is connected to the cover 43 and electrically connected to the internal electronic unit 20, while the other end extends outward through the cover 43 to outside of the electronic device casing 101. The cover 43 defines a first passage 436 allowing the plug pins 30 to extend out. Each plug pin 30 comprises a rotating section 31 and a plug-in section 34. The rotating section 31 is rotatably connected to the cover 43, while the plug-in section 34 passes through the first passage 436 to arrive outside the electronic device casing 101. The housing 10 includes a first receiving notch 102, with part of the outer casing 12 forming the sidewalls of the first receiving notch 102. On the side of the cover 43 facing the internal chamber 13, a receiving slot 432 is formed. The receiving slot 432 communicates with the first receiving notch 102. When the plug pin 30 is in the retracted position, the plug-in section 34 is received in both the receiving slot 432 and the first receiving notch 102. When the plug pin 30 is in an extended position, the plug-in section 34 is moved away from the receiving slot 432 and the first receiving notch 102 and the internal chamber 13 is in communication with the external environment via the first passage 436 and the receiving slot 432.

Specifically, the internal electronic unit 20 are electrically connected to an external socket via the plug pins 30. The plug pins 30 are metallic conductive rods serving as AC or DC input terminals. The rotating sections 31 located inside the internal chamber 13 are electrically connected to the internal electronic unit 20, while the plug-in sections 34 extend through the cover 43 via the first passage 436 to outside the electronic device casing 101, forming standard plug terminals.

The first receiving notches 102 are defined at an end of the housing 100 near the opening 15 and extends through the side wall of the whole housing 10. Parts of the outer shell 12 form the sidewalls of the first receiving notches 102. Specially, parts of the outer shell 12 extend inward toward the internal chamber 13 in each of the first receiving notches 102 and isolate the thermal spreading layer 18 from the receiving notch 102. Thus, the thermal spreading layer 18 is prevented from being exposed to the external environment at the receiving notches 102. This ensures that during the transition between the retracted and extended states of the plug pins 30, the plug pins 30 do not come into direct frictional contact with the thermal spreading layer 18, eliminating any sharp noises caused by friction and improving user experience. Additionally, a reliable insulation isolation is built between the plug pins 30 and the conductive thermal spreading layer 18 at the receiving notches 102, preventing leakage currents due to insulation failure.

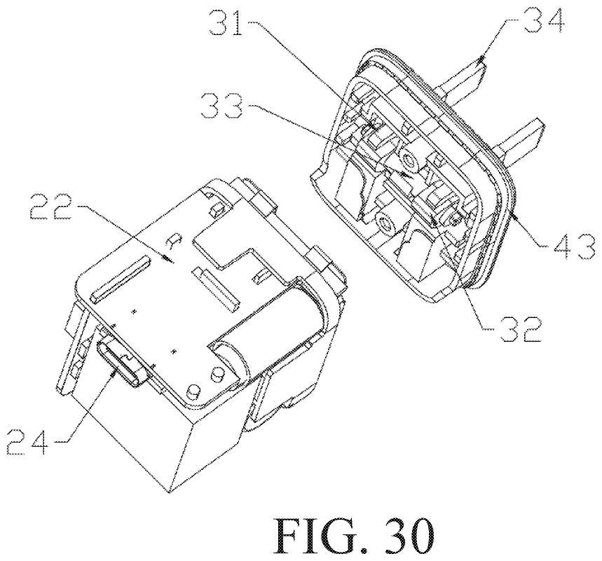

As shown in FIGS. 29 and 30, the rotating section 31 includes a bearing sleeve 32 and a rotation shaft 33. The rotation shaft 33 is mounted on the second side 4303 of the cover 43 and fixedly connected to the cover 43. The bearing sleeve 32 is fitted over the rotation shaft 33 and capable of rotating relative to the shaft 33, thus enabling the rotational connection between the plug pin 30 and the cover 43.

When in use, an external force applied to the plug-in sections 34 causes the plug pins 30 to rotate, moving them out from the first receiving notches 102 and the receiving grooves 432, transitioning from the retracted state to the extended state. When not in use, an external force may be applied to the plug-in sections 34 to rotate the plug pins 30 back into the first receiving notches 102 and the receiving grooves 432, returning them to the retracted state. This prevents the plug pins 30 from remaining exposed outside the charging device housing 100 when not needed, thereby enhancing overall user experience.

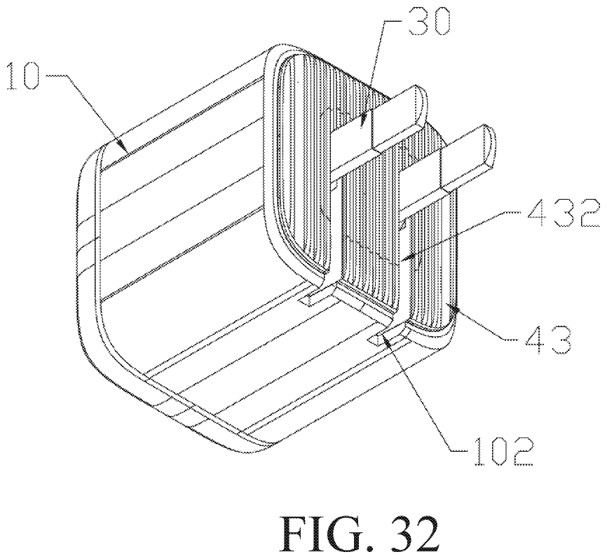

As shown in FIG. 32, when the plug pins 30 are in the extended states, the heat generated by the electric components the internal electronic unit 20 can be transferred to the rotating sections 31 of the plug pins 30 and then be directly dissipated to the external environment through the cover 43 and the first passages 436, enabling rapid heat removal. This shortens the heat transfer path and prevents heat accumulation at the junction between the rotating sections 31 and the internal electronic unit 20. Meanwhile, as shown in FIG. 32, when the plug pins 30 are in the extended states, air exchange between the inner chamber 13 and the outside is realized through the receiving grooves 432 and the first receiving notches 102, which forms an efficient heat dissipation path. Heat inside the internal chamber 13 can be rapidly transferred to the external environment via convection and radiation, avoiding heat accumulation in the internal chamber 13.

As shown in FIGS. 23 and 25, in one optional embodiment, the thermal equalization layer 18 includes a first connecting hole 180. From the end adjacent to the outer shell 12 to the opposite end, the side wall of the first connecting hole 180 gradually diverges outward relative to the central axis of the first connecting hole 180, forming a wedge-shaped space. The outer shell 12 has a second connecting hole 120. The side wall of the second connecting hole 120 extend into the first connecting hole 180 to form a wrapping section 103. The wrapping section 103 has a shape conformed to the wedge-shaped space to enclose the thermal equalization layer 18. The inner shell 14 includes a third connecting hole 140. The first connecting hole 180, the second connecting hole 120, and the third connecting hole 140 are interconnected to form a connecting hole 16, which allows insertion of a male connector terminal to form an electrical connection with the electrical connector 24 of the internal electronic unit 20.

Specifically, the male connector terminal is inserted into the connector hole 16 to electrically connect with the electrical connector 24. The side wall of the second connecting hole 120 extend into the first connecting hole 180 to form the wrapping section 103 which covers the surface of the thermal equalization layer 18. Thus, the thermal equalization layer 18 is isolated from the interior space of the first connecting hole 180 by the side wall of the second connecting hole 120, which prevents direct contact and friction between the male connector terminal and the thermal equalization layer 18 during insertion of the male connector terminal, thereby eliminating any sharp noises caused by friction and improving user experience.

Along the direction extending from the connector hole 16 into the internal chamber 13, the side wall of the first connecting hole 180 are inclined such that the distance from the central axis of the first connecting hole 180 to the side wall of the first connecting hole 180 increases progressively, forming a wedge-shaped space. A cross-section of this wedge-shaped space parallel to the central axis of the first connecting hole 180 is triangular, and the side wall of the first connecting hole 180 constitutes the hypotenuse. The shape of the wrapping section 103 matches the shape of the wedge-shaped space. The wedge-shaped space is fully filled by the wrapping section 103, which reinforces the connection between the outer shell 12 and the thermal equalization layer 18, prevents separation during operation, and prolongs the service life of the charging device 100.

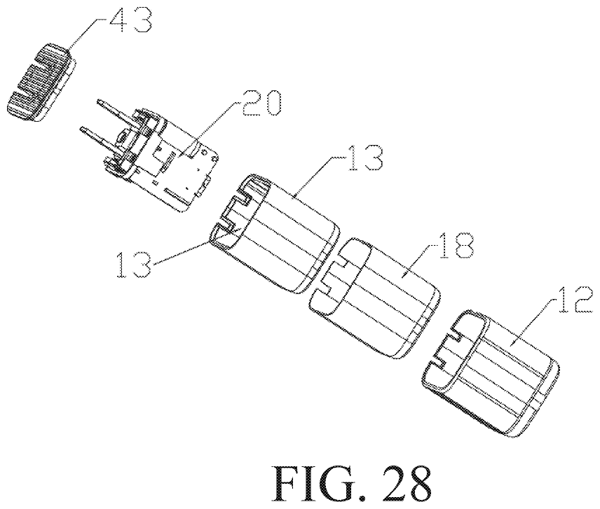

As shown in FIGS. 28 to 32, this embodiment further provides a charging device 100 which comprises the aforementioned electronic device casing 101 and the internal electronic unit 20. The internal electronic unit 20 is arranged inside the internal chamber 13 of the electronic device casing 101. The charging device 100 may be a charger, a power bank, or a hybrid device with functions of charger and power bank. The charging device 100 further includes plug pins 30 for electrical connection with a power outlet. One end of each of the plug pins 30 is located inside the internal chamber 13, connected to the cover 43 and electrically coupled to the internal electronic unit 20, while the other end extends outward through the cover 43 to outside the electronic device casing 101.

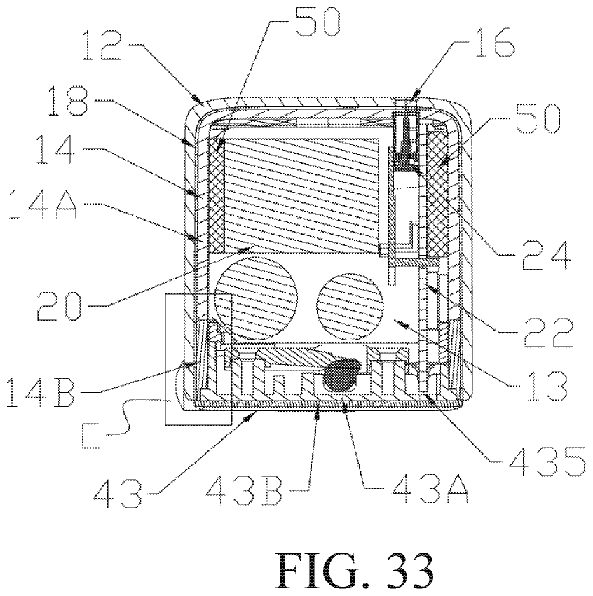

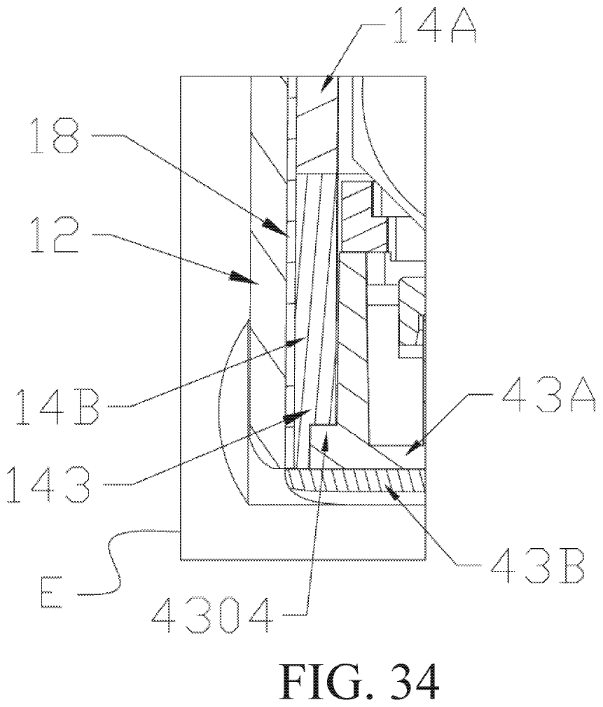

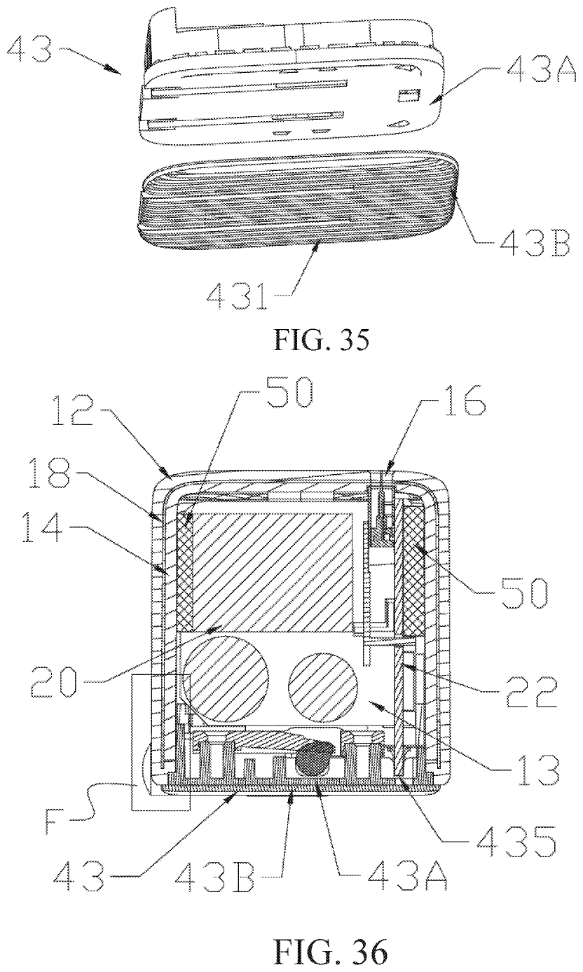

As shown in FIGS. 33 to 35, a charging device 100 in accordance with an alternative embodiment of the present invention is substantially the same as that of the above embodiment except the structures of the housing 10 and the cover 43, as well as the connection way between the cover 43 and the housing 10.

In this embodiment, at least part of the cover 43 is made of a transparent material to enhance the aesthetic appearance of the electronic device casing 101. Specifically, the cover 43 includes an inner cover 43A and an outer cover 43B connected to each other. The inner cover 43A is positioned on the side of the outer cover 43B facing the internal chamber 13. The outer cover 43B is made of a transparent material, preferably transparent polycarbonate (PC). The outer cover 43B has multiple fins 431 formed on its surface opposite to the inner cover 43A. The fins 431 may be prism-shaped protrusions configured to improve heat dissipation efficiency of the outer cover 43B. In this embodiment, the inner cover 43A is made of an opaque material, such as opaque PC. Alternatively, in other embodiments, the inner cover 43A may also be made of a transparent material. The inner cover 43A and outer cover 43B can be integrally formed via injection molding, so as to improve the strength and tightness of the joint therebetween.

In this embodiment, part of the inner shell 14 is made of a first thermal-conductive material the thermal conductivity of which is greater than that of the outer shell 12 but less than that of the thermal spreading layer 18. The thermal conductivity of the first thermal-conductive material is higher than that of conventional PC materials. The thermal conductivity of the first thermal-conductive material may range from 0.5 W/(m·K) to 3.0 W/(m·K). Specifically, the inner shell 14 comprises a main body portion 14A and a side end portion 14B connected to each other. The side end portion 14B is located at the end of the main body portion 14A adjacent to the opening 15, that is, the side end portion 14B is near the cover 43 and connected to the cover 43. The main body portion 14A is made of the first thermal-conductive material.

In this embodiment, the cover 43 is connected to the side end portion 14B via ultrasonic welding. To facilitate better ultrasonic welding between the side end portion 14B and the cover 43, the side end portion 14B is made of a material different from that of the main body portion 14A. Specifically, the side end portion 14B may adopt standard PC material to match or closely approximate the material of the cover 43, thus enhancing ultrasonic welding performance, as welding between same/like materials generally achieves better results. In other alternative embodiments, the cover 43 and the side end portion 14B can also be connected via adhesives, snap-fit joints or other means.

In this embodiment, both the inner cover 43A and the outer cover 43B are connected to the side end portion 14B via ultrasonic welding. The edge of the inner cover 43A has a first stepped section 4304, while the side end portion 14B has a second stepped section 143. The first and second stepped sections 4304/143 abut each other and are welded together via ultrasonic welding, thereby increasing the contact area, connection stability, and bonding strength between the inner cover 43A and the side end portion 14B. The edge of the outer cover 43B extends lateral outward beyond the edge of the inner cover 43A to contact the end face of the side end portion 14B. The edge of the outer cover 43B is welded to the end face of the side end portion 14B via ultrasonic welding. Additionally, the portion of the edge of the outer cover 43B beyond the end face of the side end portion 43b covers the end face of the thermal spreading layer 18, thereby preventing the thermal spreading layer 18 from being exposed to compromise aesthetics. Furthermore, the moisture in the external environment is prevented from contacting the thermal spreading layer 18 and causing corrosion. Air is blocked from entering the space between the outer shell 12 and the thermal spreading layer 18, thus preventing bubble formation and preserving aesthetics.

In this embodiment, the thermal spreading layer 18 is made of a metal material, such as aluminum or copper.

In this embodiment, the outer shell 12 is made of a transparent material, specifically transparent polycarbonate (PC), to further enhance the aesthetic appearance of the electronic device casing 101. In this embodiment, the main body portion 14A and the side end portion 14B of the inner shell 14 can be integrally molded by injection molding. The inner shell 14, thermal spreading layer 18, and outer shell 12 can be formed through a two-step overmolding process (i.e., a secondary injection molding process).

In this embodiment, an insulating thermal-conductive adhesive 50 is disposed within the internal chamber 13. The insulating thermal-conductive adhesive 50 is positioned at least in the gap between the internal electronic unit 20 and the inner wall of the inner shell 14, and contacts both the internal electronic unit 20 and the inner wall of the inner shell 14. By incorporating the insulating thermal-conductive adhesive 50, heat generated by the internal electronic unit 20 can be rapidly transferred to the inner shell 14 via the adhesive, then further conducted to the thermal spreading layer 18, and finally dissipated into the external environment through the outer shell 12, thereby significantly improving heat dissipation efficiency. Additionally, the insulating thermal-conductive adhesive 50 serves to secure the internal electronic unit 20, preventing it from shifting or vibrating inside the internal chamber 13. In this embodiment, the insulating thermal-conductive adhesive 50 may be placed in the gap between the first circuit board 22 of the internal electronic unit 20 and the inner shell 14 to quickly conduct heat away from the first circuit board 22. Alternatively, the insulating thermal-conductive adhesive 50 may also be applied in gaps between other electronic components of the internal electronic unit 20 and the inner shell 14.

The insulating thermal-conductive adhesive 50 may be formed by solidifying a liquid insulating thermal-conductive adhesive, or it may be a solid-state thermal-conductive silicone gel. Specifically, during assembly, the internal electronic unit 20 is first mounted inside the housing 10, and then the insulating thermal-conductive adhesive 50 is filled into the gap between the internal electronic unit 20 and the inner shell 14. Alternatively, in other embodiments, the insulating thermal-conductive adhesive 50 may also be placed in the gap between the internal electronic unit 20 and the cover 43 (inner cover 43A).

In this embodiment, the inner cover 43A includes a locking slot 435, into which one end of the first circuit board 22 of the internal electronic unit 20 is inserted, enabling the cover 43 to connect directly with one end of the first circuit board 22. This allows part of the heat on the first circuit board 22 to be directly transferred to the cover 43, shortening the heat conduction path. At the same time, the insertion of the first circuit board 22 into the locking slot 435 ensures a fixed connection with the cover 43, further enhancing the reliability of the connection between the cover 43 and the internal electronic unit 20.

Other structures and operating principles of this embodiment are the same as or similar to those of the above-mentioned embodiment as shown in FIGS. 17-32, and thus will not be described in detail here.

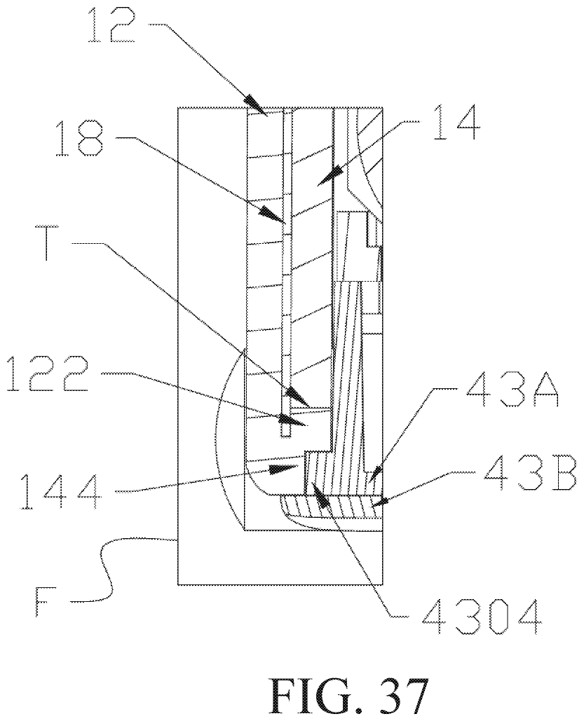

As shown in FIGS. 36 and 37, the electronic device housing 101 provided by another alternative embodiment of the present invention is substantially the same as that of the above alternative embodiment, differing in the structure of the housing 10 and the connection method between the cover 43 and the housing 10.

In this embodiment, the entire inner shell 14 is made of a first thermal-conductive material to further enhance its heat dissipation efficiency. The thermal spreading layer 18 is made of metal, while the outer shell 12 is made of transparent polycarbonate (PC) material. The cover 43 includes an inner cover 43A and an outer cover 43B connected to each other, and the inner cover 43A is positioned on the side of the outer cover 43B facing the internal chamber 13. The outer cover 43B is made of transparent material, for example transparent PC material while the inner cover 43A is made of standard PC material.

In this embodiment, the cover 43 is connected to the outer shell 12 via ultrasonic welding. Specifically, the outer shell 12 comprises a flange 122 formed at one end thereof near the opening 15 (i.e., the end of the outer shell 12 adjacent to the cover 43). The flange 122 extends inward toward the internal chamber 13. This flange 122 surrounds the end of the thermal spreading layer 18 adjacent to the opening 15 (i.e., the end of the thermal spreading layer 18 adjacent to the cover 43). The flange 122 is connected to the end of the inner shell 14 adjacent to the opening 15 (i.e., the end of the inner shell 14 adjacent to the cover 43). The thermal spreading layer 18 covers the joint area T between the flange 122 and the inner shell 14. Thus, the edges of the inner shell 14 and the outer shell 12 are connected to each other and enclose the edge of the thermal spreading layer 18 such that the thermal spreading layer 18 is fully enclosed by the inner shell 14 and the outer shell 12. The flange 122 is connected to the cover 43. Specifically, the flange 122 is connected to the cover 43 via ultrasonic welding.

Specifically, the advantage of the above structure includes: 1) By providing the flange 122 on the outer shell 12, since the materials of the outer shell 12 and the cover 43 are the same or similar, thus, the flange 122 and the cover 43 are made of the same or similar material and the effectiveness and stability of ultrasonic welding between the flange 122 and the cover 43 are improved. 2) The flange 122 surrounds the end of the thermal spreading layer 18, thus, a sealed structure is formed, which not only prevents exposure of the thermal spreading layer 18 from affecting aesthetics but also avoids contact between the thermal spreading layer 18 and moisture in the external environment, thus preventing corrosion. Additionally, outside air is prevented from entering the space between the outer shell 12 and the thermal spreading layer 18, avoiding bubble formation that could compromise appearance. 3) The thermal spreading layer 18 covers the joint area T between the flange 122 and the inner shell 14. Therefore, the seam between the flange 122 and the inner shell 14 is hidden. The overall aesthetic appearance is improved.

In this embodiment, both the inner cover 43A and the outer cover 43B are connected to the flange 122 via ultrasonic welding. The edge of the inner cover 43A forms a first stepped section 4304, while the flange portion 122 has a third stepped section 144. These two stepped sections abut each other and are welded together using ultrasonic welding, thereby increasing the contact area, connection stability, and bonding strength between the inner cover 43A and the flange 122. The edge of the outer cover 43B extends beyond that of the inner cover 43A, and the overhanging part of the outer cover 43B contacts the end face of the flange 122 and is welded thereto via ultrasonic welding.

In this embodiment, an insulating thermal-conductive adhesive 50 is also applied within the internal chamber 13. The insulating thermal-conductive adhesive 50 is located at least in the gap between the internal electronic unit 20 and the inner wall of the inner shell 14, and directly contacts both the internal electronic unit 20 and the inner wall of the inner shell 14.

Other structures and operating principles of this embodiment are the same as or similar to those of the alternative embodiment as shown in FIGS. 33-35, and thus will not be described in detail here.

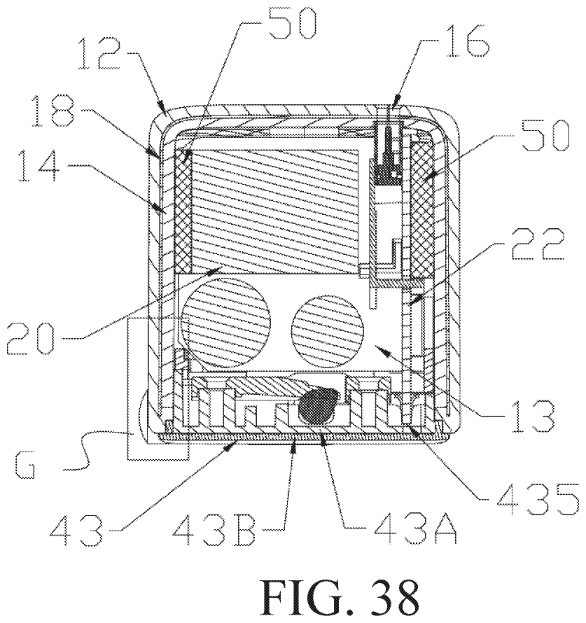

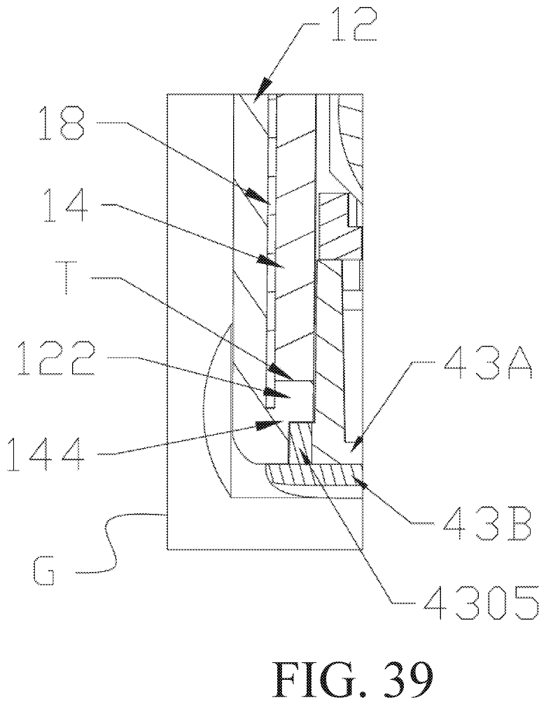

As shown in FIGS. 38 and 39, the charging device provided by further another alternative embodiment of the present invention is substantially the same as that of the another alternative embodiment as shown in FIGS. 36 and 37, differing mainly in the structure and material of the cover 43, as well as the connection way between the cover 43 and the housing 10.

In this embodiment, the structure and material of the housing 10 are the same as those in the third embodiment. The cover 43 includes an inner cover 43A and an outer cover 43B connected together, with the inner cover 43A positioned on the side of the outer cover 43B facing the internal chamber 13. The outer cover 43B is made of a transparent material, preferably transparent polycarbonate (PC). The inner cover 43A is made of a second thermal-conductive material the thermal conductivity of which is higher than that of the outer cover 43B. The second thermal-conductive material may be the same as or different from the aforementioned first thermal-conductive material. By using a thermally conductive material for the inner cover 43A, part of the heat generated by the internal electronic unit 20 can be rapidly transferred to the inner cover 43A and then quickly dissipated into the external environment through the outer cover 43B, thereby further improving heat dissipation efficiency.

Additionally, the inner cover 43A defines a locking slot 435 into which one end of the first circuit board 22 of the internal electronic unit 20 is inserted. Thus, the first circuit board 22 directly contacts the inner cover 43A, which allows part of the heat of the first circuit board 22 to be rapidly dissipated into the external environment via the inner cover 43A and the outer cover 43B.

In this embodiment, the outer cover 43B is fixed to the flange 122 of the housing 12 via ultrasonic welding. The edge of the outer cover 43B extends beyond that of the inner cover 43A, and the overhanging portion of the outer cover 43B contacts the end face of the flange 122 and is welded thereto by ultrasonic welding. Furthermore, the overhanging portion of the outer cover 43B has a protruding section 4305 extending toward the internal chamber 13, while the flange 122 has a third stepped section 144. The protruding section 4305 abuts the third stepped section 144 and is fixed together via ultrasonic welding, thereby increasing the contact area, connection stability, and bonding strength between the outer cover 43B and the flange portion 122.

In this embodiment, an insulating thermal-conductive adhesive 50 is also applied within the internal chamber 13, at least filling the gap between the internal electronic unit 20 and the inner wall of the inner shell 14, and contacting both the internal electronic unit 20 and the inner wall of the inner shell 14.

Other structures and operating principles of this embodiment are the same as or similar to those of the another alternative embodiment as shown in FIGS. 36 and 37 and thus will not be described in detail here.

In addition, it is understandable that the above embodiments are merely for an illustrative description of the present application, and the technical solutions in the embodiments of the present application may be freely combined and integrated for use without any conflict of technical features, contradiction of structures, and deviation from the objective of the present application.

Finally, it should be noted that the above embodiments are merely used for explaining the technical solution of the present application rather than limiting the present application. Although the present application has been described in detail with reference to the above-mentioned embodiments, those ordinarily skilled in the art should understand that modifications of the technical solutions recited in the embodiments or equivalent substitutions of some of the technical features in the embodiments may be still made without making corresponding technical solutions substantively depart from the spirit and scope of the technical solutions in embodiments of the present application.

What is claimed is:

1. A charging device comprising:
a housing comprising an internal chamber and an opening in communication with the internal chamber;
an internal electronic unit disposed in the internal chamber;
a cover disposed at the opening and covering the internal chamber, a surface of the cover away from the internal chamber being provided with a plurality of protrusions arranged at an interval; and
plug pins mounted to the cover, each of the plug pins comprising an end disposed in the internal chamber and electrically connected to the internal electronic unit and another end extending out of the cover.

2. The charging device according to claim 1, wherein the cover comprises receiving slots corresponding to the plug pins in a one-to-one correspondence;
the receiving slots extend in a lateral direction of the housing parallel to a length direction of the fins; and
the plug pins are movable relative to the cover between a retracted position in which the plug pins are received in the receiving slots respectively and an extended position in which the plug pins are moved out of the receiving slots.

3. The charging device according to claim 2, wherein each of the receiving slots comprises an end extending through a side wall of the cover laterally; and
when the plug pins are in the retracted position, the another ends of the plug pins extend out of the receiving slots and beyond the side wall of the cover laterally.

4. The charging device according to claim 1, wherein the internal electronic unit comprises a first circuit board and a rectifier chip which is arranged on a surface of the first circuit board adjacent to an inner wall of housing.

5. The charging device according to claim 4, wherein the internal electronic unit further comprises a second circuit board which is connected to and perpendicular with the first circuit board; and
a transformer and at least one capacitor are arranged on the second circuit board.

6. The charging device according to claim 5, wherein the at least one capacitor comprises a first capacitor and a second capacitor which are arranged at interval at an end of the circuit board adjacent to the cover, and the transformer is arranged at another end of the second circuit board away from the cover; or
the housing comprises a connecting hole arranged at an end thereof opposite to the cover, the internal electronic unit further comprises an electric connector aligning with the connecting hole, and the electric connector is arranged on the first circuit board or the second circuit board.

7. The charging device according to claim 1, wherein the plurality of protrusions is arranged at equal intervals; or
the plurality of protrusions comprises a plurality of fins which are arranged parallel to one another at equal intervals.

8. The casing according to claim 1, wherein the housing comprises an inner shell and an outer shell around the inner shell;
the internal chamber is formed within the inner shell;
an end of the outer shell is connected to the cover; and
the outer shell is made of a transparent material.

9. The charging device according to claim 1, wherein the charging device further comprises a bracket arranged in the internal chamber; and
the bracket is connected to the internal electronic unit or the cover.

10. The charging device according to claim 9, wherein the bracket has a ring structure; and/or
the bracket and the cover are separately formed and assembled together.

11. The charging device according to claim 9, wherein the bracket is a thermally-conductive bracket which comprises a ring-shaped base and a thermally-conductive extension; and
the thermally-conductive extension extends from the ring-shaped base in a direction away from the cover and is connected to the housing or the internal electronic unit.

12. The charging device according to claim 1, wherein the housing comprises an inner shell, an outer shell sleeved around the inner shell, and a thermal spreading layer disposed between the inner shell and the outer shell, and
the internal chamber is defined in the inner shell.

13. The casing according to claim 12, wherein the inner shell, the outer shell and the cover cooperatively enclose and seal the thermal spreading layer.

14. The casing according to claim 13, wherein an edge of the inner shell is connected to an edge of the outer shell such that the thermal spreading layer is enclosed and sealed between the inner shell and the outer shell; or
an edge of the cover is connected to an edge of at least one of the inner shell and the outer shell to seal the thermal spreading layer.

15. The casing according to claim 12, wherein the outer shell comprises a first bent section extending toward a center axis of the internal chamber;
the thermal spreading layer comprises a connecting portion adjacent to the opening; and
the outer shell extends beyond the thermal spreading layer in a direction parallel with the center axis of the internal chamber with the first bent section covering the connecting portion of the thermal spreading layer.

16. The casing according to claim 12, wherein the inner shell and the outer shell both are made of electrically insulating material, and the thermal spreading layer is made of metal; or
at least a portion of the inner shell is made of a thermal-conductive material with a thermal conductivity greater than that of the outer shell but less than that of the thermal spreading layer.

17. The casing according to claim 12, wherein a connecting hole extends through the outer shell, the thermal spreading layer and the inner shell sequentially to allow a male connector terminal to pass therethrough to electrically connect with the internal electronic unit; and
a wrapping section extends from the inner shell or the outer shell to cover a portion, surrounding the connecting hole, of the thermal equalization layer and isolate the male connector terminal from the thermal equalization layer.

18. A charging device, comprising:
a housing comprising an internal chamber and an opening in communication with the internal chamber;
an internal electronic unit disposed in the internal chamber;
a cover attached to the housing and covering the internal chamber;
a thermally-conductive bracket arranged in the internal chamber and in thermal conduction with the internal electronic unit and the cover; and
plug pins mounted to the cover, each of the plug pins comprising an end disposed inside the internal chamber and electrically connected to the internal electronic unit, and another end extending through the cover to outside the internal chamber.

19. The charging device according to claim 18, wherein the cover is arranged at the opening; and
a surface, facing away from the housing, of the cover is exposed out of the inner chamber and provided with a plurality of fins arranged at an interval.

20. The charging device according to claim 18, wherein the internal electronic unit comprises a first circuit board and a second circuit board, the first circuit board and the second circuit board are perpendicular to each other, and at least one of the first circuit board and the second circuit board is connected to the thermally-conductive bracket.
